(19) United States
(12) Patent Application Publication
(10) Pub. No.: US 2026/0065630 A1
(43) Pub. Date: Mar. 5, 2026

(54) LANGUAGE MODEL INTERFACE FOR GENERATING NATURAL LANGUAGE RESPONSES FOR SCREEN CAPTURES

(71) Applicant: Zeta Global Corp., New York, NY (US)

(72) Inventors: Brennan T Plowman, Columbus, OH (US); Winne Shen, New York, NY (US); Neej Gore, San Francisco, CA (US); Bashir Eghbali, San Francisco, CA (US)

(21) Appl. No.: 19/313,827

(22) Filed: Aug. 28, 2025

Related U.S. Application Data
(60) Provisional application No. 63/687,778, filed on Aug. 28, 2024.

(51) Int. Cl. G06V 10/70; G06F 9/451

(52) U.S. Cl. CPC G06V 10/70; G06F 9/451

(57) ABSTRACT

The subject technology includes a language model interface for generating natural language insights for objects included in a particular UI page. The language model interface may train application specific language models based on features determined from snapshot data of application UI pages. The features may include snapshot features derived from multi-modal embeddings. To train the application models using the snapshot features, system prompts may be constructed. The system prompts may include natural language descriptions determined by mapping the multi-modal embeddings to a trained text feature space. The language model interface may also include one or more coordination components for making the generated responses available to the application and optimizing the performance of the language models.

### PRIORITY CLAIM

This patent application claims the benefit of priority, under 35 U.S.C. Section 119(e), to Plowman et al, U.S. Provisional Patent Application Ser. No. 63/687,778, entitled “LANGUAGE MODEL INTERFACE FOR GENERATING TEXT RESPONSES FOR SCREEN CAPTURES,” filed on Aug. 28, 2024 (Attorney Docket No. 4525.202PRV), which is hereby incorporated by reference in its entirety.

### TECHNICAL FIELD

The subject matter disclosed herein generally relates to the technical field of machine learning and, more specifically, techniques for training and using machine learning models to improve the performance of applications that generate and display data visualizations.

### BACKGROUND

Language models including large language models (LLMs) and other forms of generative AI are powerful tools that may assist humans with a wide range of tasks, including information retrieval, summarization, data analysis, and acting on the user's behalf. To carry out these tasks, it is necessary to develop application interfaces that integrate language models within applications having different characteristics and features. Language model interfaces may train specific language models on datasets that are relevant to particular applications. The language model interfaces may also provide one or more coordination components that integrate the language models with the other features of the application. The coordination components may, for example, embed the language models within specific workflows that are executed within the application, connect the language models to components that provide other application features, and optimize the language models for one or more tasks completed within the application.

The inventors here have recognized several technical problems with conventional language model interfaces, as explained below. Language model interfaces are currently built for general purpose language models that perform natural language tasks. Accordingly, current interfaces support training on limited datasets that include text and/or structured data. Training and fine tuning using datasets including unstructured data, for example, images, video, audio files, and the like is not supported, therefore, current language model interfaces are not suitable for applications with visual features (e.g., applications that generate and display data visualizations such as graphs, charts, tables, and the like). Additionally, current language model interfaces lack the capacity to integrate language models directly into application workflows which limits how users can interact with the language models and creates fiction for users who want to have interactive experiences with the language models. For example, to provide access to language models during an ongoing project in an application, current interfaces may require users to record previous interactions with an application and provide the recorded interactions to a language model as part of an input query. This process is time intensive and reduces the number of language model interfaces users will have. It would be desirable to create a language model interface that could automatically capture application interactions and other user specific context and use the captured data to optimize the performance and outputs of the language models. It would also be desirable to create a language model interface that can use the captured application interactions and context to configure language models in a way that provides sufficient levels of user specific precision and context awareness to enable the models to deliver outputs that are relevant to ongoing projects performed in an application. For example, it would be desirable to create a language model interface that configures language models based on a user selected context indicated by previous application interactions within an application.

The language models currently being developed are complex machine learning models that may include millions, billions, and even trillions of trainable parameters. The complexity and size of these language models makes the models computationally intensive to train and inference. Due to the heavy compute requirements and high inference costs of language models, it would be advantageous to create language model interfaces that may improve the efficiency of applications having integrated language models. For example, it would be advantageous the develop language model interfaces that may reduce the number of language model requests required to provide the AI system functionality within an application.

### SUMMARY

The language model interface described herein improves the performance, speed, and reliability of applications that use language models to provide specific functionality. The language model interface includes a capture mechanism that collects a snapshot of a current state of an application (e.g., a current state of a task performed in an application). The snapshot may include visual aspects (e.g., screenshots, data visualizations, other images displayed in the application), application interactions (e.g., selections, filters, configurations, and the like) performed to generate the visual aspects, and other context data about the user and particular project they are working on. The snapshots may be used by the language model interface to train and optimize language models for particular users, tasks, and applications. For example, language models may be trained on training samples including a diverse set of snapshots and example insights generated from each snapshot to enable to model to develop a deeper understanding of how different visual presentations correlate with data insights. The training samples may include a sample of snapshots from a variety of contexts, snapshots including images of different types of visualizations, snapshots for a variety of different tasks, and the like. The understanding of the relationships between data visualizations in the snapshots and relevant insights drawn from the data visualizations improves the relevance and context awareness of the analysis provided by the language models by enabling the trained models to extract nuanced insights from visual layouts and anticipate the decision making support desired by users. The training on snapshots including specific combinations of unstructured data (e.g., image data, audio, application data, and the like) and structured data (e.g., text, example insights, user context data, and the like) enables the model to generate more precise and actionable recommendations that are more likely to improve one or more outcomes desired by the user.

The language model interface also includes a custom prompt generation process used during training and inference. At training, custom prompts are generated from each snapshot so that a complete picture of the task embodied in the snapshot is provided to the language model.

During inference, custom prompts are used to generate model outputs. The custom prompts provide the full user context to the model and include context and task specific output guidelines that improve the consistency and quality of the insights and recommendations provided by the model.

The language model interface also includes a configuration based caching mechanism that improves the efficiency of the language model operations of the application and reduces the compute and cost required for model inference. The configuration based caching mechanism selectively reuses previously generated insights and recommendations to reduce the number of requests distributed to language models. The caching mechanism dynamically adjusts to context extracted from user snapshots to selectively reuse relevant language model outputs without sacrificing the relevance or usefulness of the outputs.

### BRIEF DESCRIPTION OF THE DRAWINGS

Some embodiments are illustrated by way of example and not limitation in the figures of the accompanying drawings.

FIG. 1 is a block diagram illustrating a high-level network architecture, according to various embodiments described herein.

FIG. 2 is a block diagram showing architectural aspects of a learning module, according to various embodiments described herein.

FIG. 3 is a block diagram illustrating a representative software architecture, which may be used in conjunction with various hardware architectures herein described.

FIG. 4 is a block diagram illustrating components of a machine, according to some example embodiments, able to read instructions from a machine-readable medium (e.g., a machine-readable storage medium) and perform any one or more of the methodologies discussed herein.

FIG. 5 depicts aspects of an implementation of one or more components of an application server, according to various embodiments described herein.

FIG. 6 depicts aspects of a learning module, according to various embodiments described herein.

FIG. 7 illustrates aspects of a training process for application models, according to various embodiments described herein.

FIG. 8 illustrates aspects of a process for using a language model interface to provide AI system functionality for an application, according to various embodiments described herein.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

The embodiments discussed herein involve or relate to artificial intelligence (AI). AI may involve perceiving, synthesizing, inferring, predicting and/or generating information using computerized tools and techniques (e.g., machine learning). For example, AI systems may use a combination of hardware and software as a foundation for rapidly performing complex operations to perceive, synthesize, infer, predict, and/or generate information. AI systems may use one or more models, which may have a particular configuration (e.g., model parameters and relationships between those parameters, as discussed below). While a model may have an initial configuration, this configuration can change over time as the model learns from input data (e.g., training data), which allows the model to improve its abilities. For example, a training sample may be input to a model, which may produce an output based on the sample and the configuration of the model itself. Then, based on additional information (e.g., an additional training sample, validation data, reference data, feedback data), the model may deduce and automatically electronically implement a change to its configuration that will lead to an improved output.

Powerful combinations of model parameters and sufficiently large datasets, together with high-processing-capability hardware, can produce sophisticated models. These models enable AI systems to interpret incredible amounts of information according to the model being used, which would otherwise be impractical, if not impossible, for the human mind to accomplish. The results, including the results of the embodiments discussed herein, are astounding across a variety of applications. For example, an AI system can be configured to autonomously analyze images, navigate vehicles, automatically recognize objects, instantly generate natural language, understand human speech, and generate artistic images.

The technology described herein provides an improved language model interface that may integrate language models with one or more applications to provide AI system functionality. For example, the language model interface may integrate language models with one or more applications that generate and display data visualizations to provide autonomous data analysis and instant generation of insights and actionable recommendations. The language model interface may train and optimize language models for application specific datasets that include image data. Incorporating images into training samples and input data provided to language models during inference may improve the specificity, relevance, and usability of the insights and recommendations provided by the language models. The language model interface may also include one or more coordination components that capture screenshots, data visualizations, and other image data displayed by the application. The captured image data may be combined with user selected parameters and other previously recorded application interactions and context data to generate snapshots that are used for model training and are provided to the models during inference. The data capture components may integrate language models directly into application workflows to enable users to get more relevant and actionable outputs from the language models. The coordination components may also include an insights cache that may improve the performance of the language models and applications with integrated AI systems by reducing the number of language model requests required to provide the desired insights.

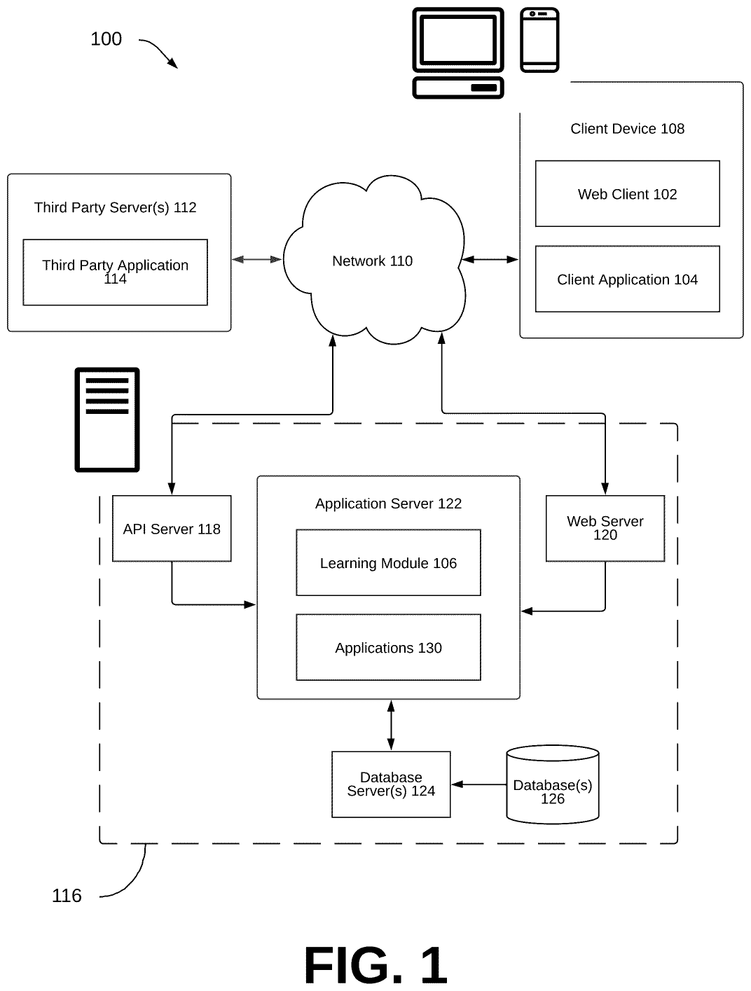

The language model interface may be implemented within a learning module included in the SaaS network architecture described in FIG. 1 below so that the model training and coordination functionality may be scaled within architectures that supports multiple language models and multiple applications having AI features. The SaaS network architecture also enables applications using the language model interface to run on multiple client devices. With reference to FIG. 1, an example embodiment of a high-level SaaS network architecture 100 is shown. A networked system 116 provides server-side functionality via a network 110 (e.g., the Internet or WAN) to a client device 108 (e.g., an internet enabled device). A web client 102 and a programmatic client, in the example form of a client application 104, are hosted and execute on the client device 108.

The networked system 116 includes an application server 122, which in turn hosts one or more applications 130 (e.g., server side applications configured to provide functionality and/or content to end-user clients) that provide a number of functions and services to the client application 104 that accesses the networked system 116. The client application 104 may provide a number of graphical user interfaces (GUIs) described herein that may be displayed on one or more client devices 108 and may receive inputs thereto to configure an instance of the client application 104 and monitor operations performed by the application server 122. For example, the client application 104 may provide conversational user interfaces (UIs) for interacting with language models. To interact with language models, users may enter request in the form of natural language prompts into the conversational UIs and content items including image data and natural language text generated by the language models in response to requests may be displayed in the conversational UIs. The GUIs provided by the client application 104 may present outputs to a user of the client device 108 and receive inputs thereto in accordance with the methods described herein.

The client device 108 enables a user to access and interact with the networked system 116 and, ultimately, the learning module 106 or other applications 130 hosted by the application server 122. For instance, the user provides input (e.g., touch screen input or alphanumeric input) to the client device 108, and the input is communicated to the networked system 116 via the network 110. In this instance, the networked system 116, in response to receiving the input from the user, communicates information back to the client device 108 via the network 110 to be presented to the user.

An API server 118 and a web server 120 are coupled, and provide programmatic and web interfaces respectively, to the application server 122. The application server 122 hosts the learning module 106, which includes components or applications described further below. The application server 122 may also host one or more applications 130 that are linked to the learning module 106. For example, the application server 122 may host a publishing application that distributes one or more pieces of content including image data or other media generated by a generative system (e.g., a language model configured for content generation) included in the learning module 106. The application server 122 is, in turn, shown to be coupled to a database server 124 that facilitates access to information storage repositories (e.g., a database 126). In an example embodiment, the database 126 includes storage devices that store information accessed and generated by the learning module 106 and/or applications 130.

Additionally, a third-party application 114, executing on one or more third-party servers 112, is shown as having programmatic access to the networked system 116 via the programmatic interface provided by the API server 118. For example, the third-party application 114, using information retrieved from the networked system 116, may support one or more features or functions of a generative AI system, website, streaming platform, and the like hosted by a third party.

Turning now specifically to the applications hosted by the client device 108, the web client 102 may access the various systems (e.g., the learning module 106) via the web interface supported by the web server 120. Similarly, the client application 104 (e.g., an agent evaluation “app”) accesses the various services and functions provided by the learning module 106 via the programmatic interface provided by the API server 118. The client application 104 may be, for example, an “app” executing on the client device 108, such as an iOS or Android OS application, and/or a desktop application, web application, or other software application to enable a user to access and input data on the networked system 116 in an offline manner and to perform batch-mode communications between the client application 104 and the networked system 116.

FIG. 1 illustrates one embodiment of the network architecture 100 and other embodiments may include one or more other components and/or configurations. For example, one or more of the learning module 106 and/or applications may be hosted by its own server. Further, while the SaaS network architecture 100 shown in FIG. 1 employs a client-server architecture, the present inventive subject matter is of course not limited to such an architecture, and could equally well find application in a distributed, or peer-to-peer, architecture system, for example. The learning module 106 could also be implemented as a standalone software program, which does not necessarily have networking capabilities.

In various embodiments, the learning module 106 may include a language model interface hosted by a coordination server. The coordination server may provide the language model interface to the application server 122 to enable one or more applications hosted by the application server to use language models to provide AI system functionality. The coordination server may train and/or optimize language models for one or more applications hosted by the application server 122 to improve the utility and user experience of the AI features provided by the applications. The coordination server may also provide coordination components that enable image data to be used for model training and inference and improve the performance of the language models and applications with AI features by limiting the number of language model requests required to provide desired AI system functionality. The coordination server may also provide one or more agentic applications to publishing applications hosted by the application server to enable autonomous configuration of media campaigns.

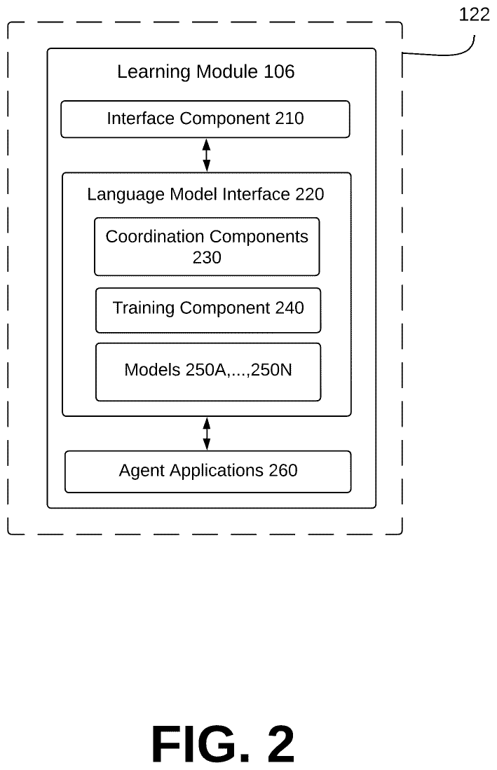

FIG. 2 is a block diagram showing architectural details of a learning module 106, according to some example embodiments. Specifically, the learning module 106 is shown to include an interface component 210 by which the learning module 106 communicates (e.g., over a network 110) with other systems within the SaaS network architecture of FIG. 1.

The interface component 210 may be coupled to a language model interface 220 that may connect one or more applications hosted by an application server to one or more language models and/or AI systems. The interface component 210 may be an application interface the directly links one or more applications to the language model interface 220 to enable the applications to integrate one or more AI system features into the applications. For example, the interface component 210 may send API requests or other messages to a language model interface 220 coupled to an AI system (e.g., the agent applications 260) to deliver one or more AI outputs (e.g., autonomous data analysis, instant generation of text insights and recommendations, and the like) in the application. The interface component 210 may also display one or more UIs the enable users to interact with AI systems directly via the language model interface 220.

The language model interface 220 may include coordination components 230 that integrate the agent applications 260 with one or more applications to enable the applications to deliver analysis, insights, and recommendations requested by users. The coordination components 230 may include one or more data capture components that may capture screenshots, data visualizations, and other image data displayed in the applications. The training components 240 of the language model interface may assemble the captured image data along with application interactions and/or context data into snapshots that are used to train one or more models 250A, . . . ,250N. The models 250A, . . . ,250N may include one or more encoders that generate snapshot features and one or more language models that generate natural language responses for specific UI pages. The snapshots may also be provided to the models 250A, . . . ,250A during inference to improve the context awareness of the models 250A, . . . ,250N and the relevance, utility, and actionability outputs generated by the models 250A, . . . ,250N. The coordination components 230 may also include a context specific data cache that may be used to improve the performance of one or more of the models 250A, . . . ,250N and/or applications that use the models 250A, . . . ,250N to provide system functionality.

The learning module 106 may also include one or more agent applications 260 that may use one or more language models selected from the models 250A, . . . ,250N to perform one or more tasks. The agent applications 260 may be an agentic application that may perform one or more plan and execution cycles to generate outputs from the language models and/or modify the outputs to generate responses to requests received from one or more applications via the interface component 210. The language model interface 220 may integrate AI system functionality provided by the agent applications 260 into one or more applications hosted by the application server 122 that are connected to the interface component 210.

It should be understood that the learning module 106 may include one or more instances of each of the components. For example, the learning module 106 may include multiple interface components 210 with each instance being operated to access a different application hosted by the application server 122. The learning model 106 may also include multiple language model interfaces 220 and/or multiple agent applications 260 with each interface being configured to integrate one of the agents with one or more of the applications.

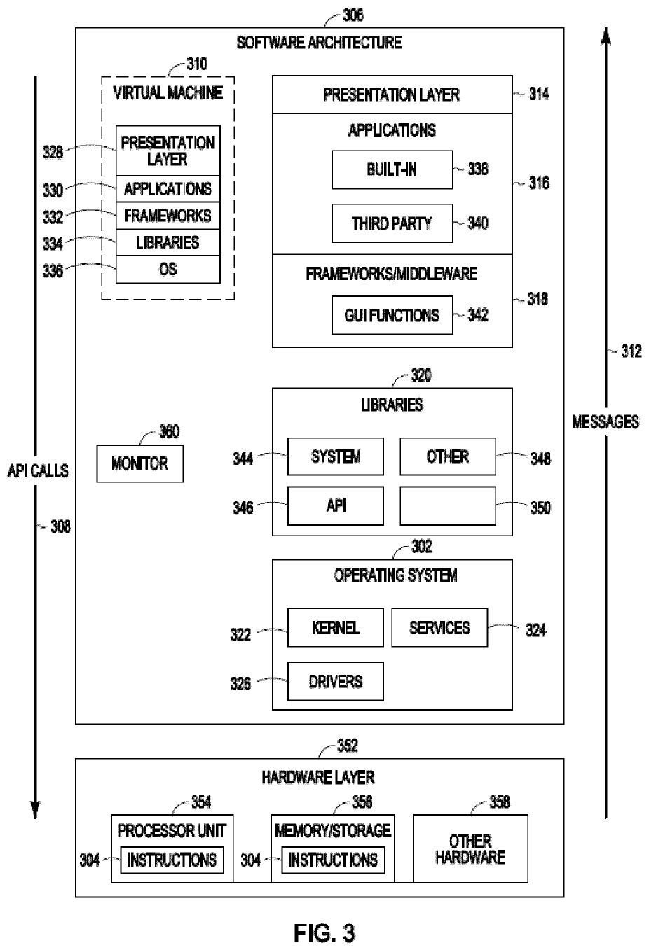

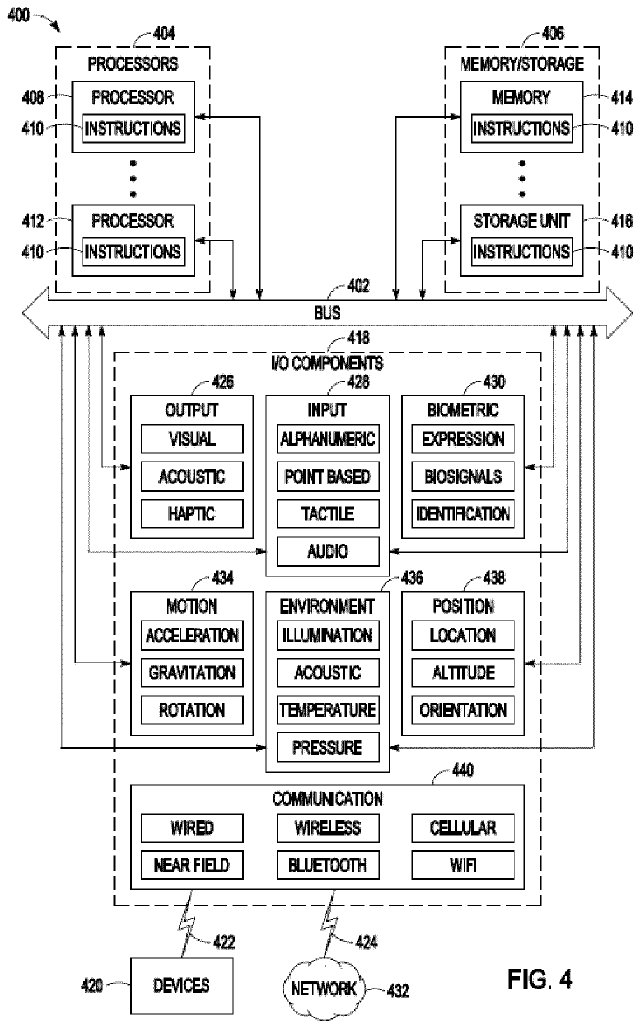

FIG. 3 is a block diagram illustrating an example software architecture 306, which may be used in conjunction with various hardware architectures herein described. FIG. 3 is a non-limiting example of a software architecture 306, and it will be appreciated that many other architectures may be implemented to facilitate the functionality described herein. The software architecture 306 may execute on hardware such as a machine 400 of FIG. 4 that includes, among other things, processors 404, memory/storage 406, and input/output (I/O) components 418. A representative hardware layer 352 is illustrated and can represent, for example, the machine 400 of FIG. 4. The representative hardware layer 352 includes a processor 354 having associated executable instructions 304. The executable instructions 304 represent the executable instructions of the software architecture 306, including implementation of the methods, components, and so forth described herein. The hardware layer 352 also includes memory and/or storage modules as memory/storage 356, which also have the executable instructions 304. The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, frameworks/middleware 318, applications 316, and a presentation layer 314. Operationally, the applications 316 and/or other components within the layers may invoke API calls 308 through the software stack and receive a response as messages 312 in response to the API calls 308. The layers illustrated are representative in nature, and not all software architectures have all layers. For example, some mobile or special-purpose operating systems may not provide a frameworks/middleware 318, while others may provide such a layer. Other software architectures may include additional or different layers.

The operating system 302 may manage hardware resources and provide common services. The operating system 302 may include, for example, a kernel 322, services 324, and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than by interfacing directly with the underlying operating system 302 functionality (e.g., kernel 322, services 324, and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/modules.

The frameworks/middleware 318 provide a higher-level common infrastructure that may be used by the applications 316 and/or other software components/modules. For example, the frameworks/middleware 318 may provide various graphic user interface (GUI) functions 342, high-level resource management, high-level location services, and so forth. The frameworks/middleware 318 may provide a broad spectrum of other APIs that may be utilized by the applications 316 and/or other software components/modules, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, a publishing application, a content application, a campaign configuration application, performance monitoring application, a scoring application, and/or a game application. The third-party applications 340 may include any application developed using the ANDROID™ or IOS™ software development kit (SDK) by an entity other than the vendor of the particular platform and may be mobile software running on a mobile operating system such as IOS™, ANDROID™, WINDOWS® Phone, or other mobile operating systems. The third-party applications 340 may invoke the API calls 308 provided by the mobile operating system (such as the operating system 302) to facilitate functionality described herein.

The applications 316 may use built-in operating system functions (e.g., kernel 322, services 324, and/or drivers 326), libraries 320, and frameworks/middleware 318 to create user interfaces to interact with users of the system. Alternatively, or additionally, in some systems, interactions with a user may occur through a presentation layer, such as the presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 400 of FIG. 4, for example). The virtual machine 310 is hosted by a host operating system (e.g., the operating system 302 in FIG. 3) and typically, although not always, has a virtual machine monitor 360, which manages the operation of the virtual machine 310 as well as the interface with the host operating system (e.g., the operating system 302). A software architecture executes within the virtual machine 310 such as an operating system (OS) 336, libraries 334, frameworks 332, applications 330, and/or a presentation layer 328. These layers of software architecture executing within the virtual machine 310 can be the same as corresponding layers previously described or may be different.

FIG. 4 is a block diagram illustrating components of a machine 400, according to some example embodiments, able to read instructions from a non-transitory machine-readable medium (e.g., a non-transitory machine-readable storage medium) and perform any one or more of the methodologies discussed herein. Specifically, FIG. 4 shows a diagrammatic representation of the machine 400 in the example form of a computer system, within which instructions 410 (e.g., software, a program, an application, an applet, an app, or other executable code) for causing the machine 400 to perform any one or more of the methodologies discussed herein may be executed. As such, the instructions 410 may be used to implement modules or components described herein. The instructions 410 transform the general, non-programmed machine 400 into a particular machine 400 programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while only a single machine 400 is illustrated, the term “machine” shall also be taken to include a collection of machines that individually or jointly execute the instructions 410 to perform any one or more of the methodologies discussed herein.

The machine 400 may include processors 404 (including processors 408 and 412), memory/storage 406, and I/O components 418, which may be configured to communicate with each other such as via a bus 402. The memory/storage 406 may include a memory 414, such as a main memory, or other memory storage, and a storage unit 416, both accessible to the processors 404 such as via the bus 402. The storage unit 416 and memory 414 store the instructions 410 embodying any one or more of the methodologies or functions described herein. The instructions 410 may also reside, completely or partially, within the memory 414, within the storage unit 416, within at least one of the processors 404 (e.g., within the processor's cache memory), or any suitable combination thereof, during execution thereof by the machine 400. Accordingly, the memory 414, the storage unit 416, and the memory of the processors 404 are examples of machine-readable media.

The I/O components 418 may include a wide variety of components to receive input, provide output, produce output, transmit information, exchange information, capture measurements, and so on. The specific I/O components 418 that are included in a particular machine will depend on the type of machine. For example, portable machines such as mobile phones will likely include a touch input device or other such input mechanisms, while a headless server machine will likely not include such a touch input device. It will be appreciated that the I/O components 418 may include many other components that are not shown in FIG. 4. The I/O components 418 are grouped according to functionality merely for simplifying the following discussion, and the grouping is in no way limiting. In various example embodiments, the I/O components 418 may include output components 426 and input components 428. The output components 426 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 418 may include biometric components 430, motion components 434, environment components 436, or position components 438, among a wide array of other components. For example, the biometric components 430 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 434 may include acceleration sensor components (e.g., accelerometer), gravitation sensor components, rotation sensor components (e.g., gyroscope), and so forth. The environment components 436 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 418 may include communication components 440 operable to couple the machine 400 to a network 432 or devices 420 via a coupling 424 and a coupling 422, respectively. For example, the communication components 440 may include a network interface component or other suitable device to interface with the network 432. In further examples, the communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 420 may be another machine or any of a wide variety of peripheral devices (e.g., a peripheral device coupled via a USB).

Moreover, the communication components 440 may detect identifiers or include components operable to detect identifiers. For example, the communication components 440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geo-location, location via Wi-Fi® signal triangulation, location via detecting an NFC beacon signal that may indicate a particular location, and so forth.

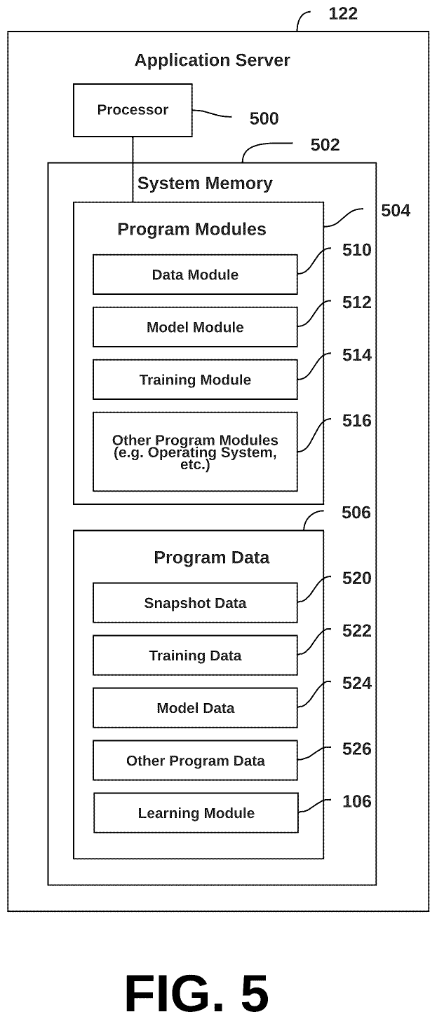

FIG. 5 illustrates an application server 122 hosting a learning module. The application server 122 may include at least one processor 500 coupled to a system memory 502 that may include computer program modules 504 and program data 506. In various embodiments, program modules 504 may include a data module 510, a model module 512, a training module 514, and other program modules 516 such as an operating system, device drivers, and so forth. Each module 510 through 516 may include a respective set of computer-program instructions executable by one or more processors 500.

This is one example of a set of program modules, and other numbers and arrangements of program modules are contemplated as a function of the particular design and/or architecture of the learning module. Additionally, although shown as a single application server, the operations associated with respective computer-program instructions in the program modules 504 could be distributed across multiple computing devices. Program data 506 may include data, program instructions, and other resources consumed by the program modules 504 to provide the functionality described herein. In various embodiments, program data 506 may include snapshot data 520, training data 522, model data 524, and other program data 526 such as data input(s), third-party data, and/or others. Program data 506 may also include instructions, data, and other resources used to implement the learning module described further below.

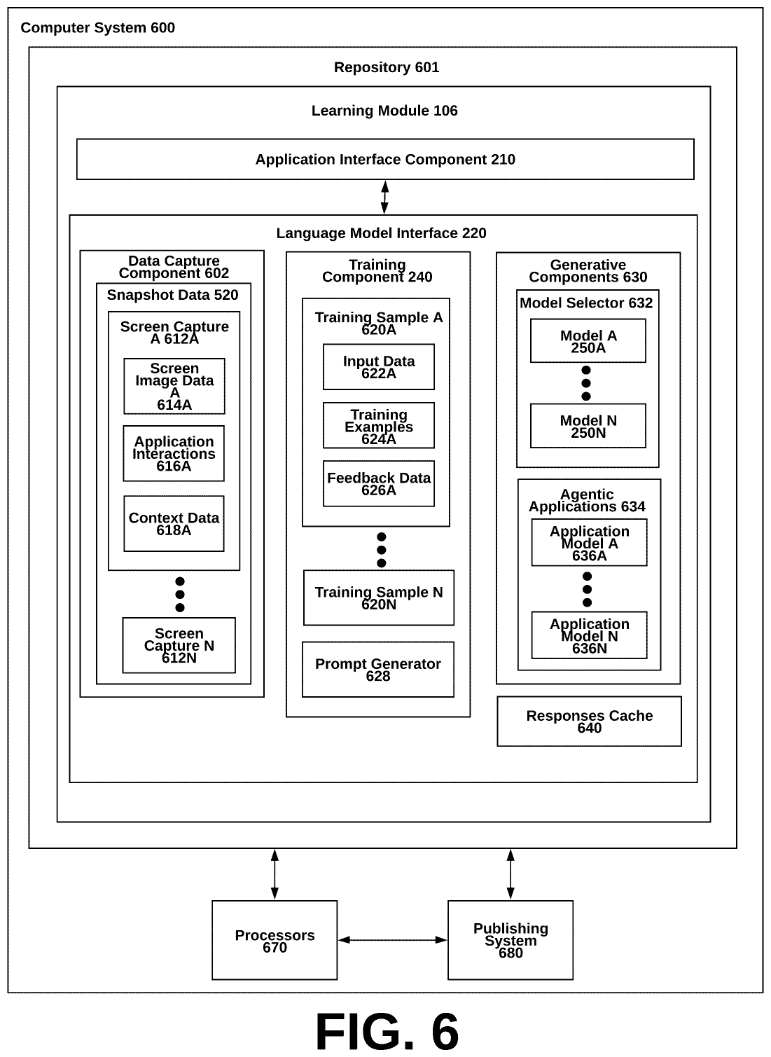

FIG. 6 is a block diagram illustrating more details of the learning module 106 in accordance with one or more embodiments of the disclosure. The learning module 106 may be implemented using a computer system 600 that may include a repository 601, publishing system 680, and one or more computer processors 670. The computer system 600 may take the form of the application server 122 described above in FIG. 1 or any other computer including a processor and memory. The computer processor(s) 670 may take the form of the processor 500 described in FIG. 5.

The learning module 106 may include an application interface component 210 connected to one or more language model interfaces 220. The application interface component 210 may enable one or more applications hosted by the application server to interact with the language model interface 220 to integrate AI system functionality into the one or more applications. For example, the applications may use the application interface component 210 to send text generation requests (e.g., request messages formatted as language model prompts) to the language model interface 220 and receive responses (e.g., completions generated by language models that are formatted as response messages) in return. To generate the responses, the language model interface 220 may generate a user prompt that includes the text generation request and one or more pieces of snapshot data 520 captured by the language model interface 220. The language model interface 220 may train one or more language models 250A, . . . ,250 using the snapshot data 520 to generate one or more application models 636A, . . . ,636N that are specific to the application. The language model interface 220 may may display the user prompt to one or more of the application models 636A, . . . ,636N to generate a response for the text generation request. The application interface component 210 may receive the responses from the language model interface 220 and display the responses in one or more UIs of the application to deliver the responses to users.

The language model interface 220 may include one or more coordination components, one or more training components 240, and one or more generative components 630. The coordination components may integrate AI system functionality provided by the generative components 630 into one or more applications. For example, the coordination components may include a data capture component 602 that captures data from the applications that is needed by the generative components 630 to generate responses to text generation requests and deliver the responses to the applications. The coordination components may also include a responses cache 640 that improves the performance and efficiency of the generative components 630 to reduce the compute and cost required to provide AI system functionality to the applications.

The training components 240 may train one or more application specific language models (e.g., application models 636A, . . . ,636N) that may be used to provide specific AI system functionality within one or more applications. The training components 240 may generate one or more training samples 620A, . . . ,620N that are used to train application specific versions of the language models 250A, . . . ,250N. For example, the training components 240 may generate application specific training samples 620A, . . . ,620N that include snapshot data 520 captured from one or more applications by the data capture component 602. The training components 240 may also include a prompt generator 628 that generates application specific language model prompts for model training and model inference. The prompts may include one or more application and/or task specific response guidelines that may improve the consistency and quality of the outputs generated by the application models 636A, . . . , 636N.

The generative components 630 may use the application models 636A, . . . ,636N and/or agentic applications 634 to provide AI system functionality to one or more applications. For example, the application models 636A, . . . ,636N may be used to generate responses to text generation requests. The application models 636A, . . . ,636N may also generate one or more outputs that are used by agentic applications 634 to perform one or more actions required to complete tasks included in the text generation requests. Feedback data (e.g., user feedback, performance metrics for one or more pre-determined goals, and the like) for the responses generated and/or actions performed by the generative components 630 may be collected by the applications. The feedback data may be incorporated into one or more re-training samples that are used to retrain one or more of the application models 636A, . . . ,636N to improve the performance of the models over time.

The coordination components may include one or more data capture components 602 that capture snapshot data 520 from one or more applications. The data capture component 602 may capture snapshot data 520 from the applications by accessing UI pages generated by the application using the application interface component 210 (e.g., an application programming interface (API) for the application). For example, the data capture component 602 may send commands to the application interface component 210 to access screen image data displayed in application UI pages and/or retrieve and/or one or more pieces of application data (e.g., context data for a user and/or dataset, application interactions used to generate a UI page, and the like) from the application. The snapshot data 520 may include one or more screen captures 612A, . . . ,612N that capture a current state of the application. The screen captures 612A, . . . , 612N may include screen image data 614A of a UI page displayed on a screen by the application. The screen image data 614A may include a screenshot of one or more portions of the UI page displayed at the time the screen capture 612A was recorded. For example, the screen image data 614A may include screenshots of an image, object, graph, chart table, and/or other aspects of UI pages displayed by the application.

The screen image data 614A may also include screenshots capturing one or more application interactions 616A (e.g., selections, configurations, filters, highlights, text inputs, drawings, and like) that are visible in the UI page. To capture the application interactions 616A, the screen image data 614A may include screenshots of a side bar, panel, menu, and/or other portion of a UI that a user may interact with to generate and/or modify a graph or other object displayed in a UI page. For example, the screen image data 614A may include screenshots of an area of the UI where users select a type of graph or object to create, select the data shown in the graph, apply one or more filters to the data, configure one or more graph axes or other components of the selected object, and the like. The screen image data 614A may also include screenshots of portions of the UI page that include text, highlights, lines, arrows, drawings, or other markings made to modify and/or distinguish a portion of the graph or other objects included in the UI page. For example, the screen image data 614A may include screenshots of a portion of the UI page that shows changes to one of the values of the graph and/or arrows or other markings that draw attention to a portion of the graph.

To capture the screen image data 614A, the data capture component 602 may send a command to the application interface component 210 to retrieve a markup language format an application UI page. The data capture component 602 may parse the markup language format (e.g., HTML, CSS, and the like) of the application UI page to identity one or more target UI elements within the page. The data capture component 602 may map the target UI elements identified in the markup language format to a position within the UI page. The data capture component 602 may also map the position of the UI page including the target UI elements to a pixel area of a display of the UI page on a screen of a user device (e.g., computer and/or internet enabled device). The data capture component 602 may capture a screenshot that includes image data of the pixels in the pixel area that maps to the portion of the UI page that contains the target UI elements. For example, the data capture component 602 may search for a target UI element (e.g., a button, icon, text field, toggle, and the like) contained within a section of the markup language format of the UI page. The data capture component 602 may locate the target element by searching the UI elements located within sections of the markup language format of the UI page that are separated by a tag (e.g., <div>, i.e., division tag). The data capture component 602 may map all of the target UI elements within the tag and/or parent tag (e.g., parent <div>) to a position on the UI page, map the position on the UI page to a pixel area of a device screen, and capture a screenshot that includes screen image data of the pixels in the pixel area that map to the section of the UI page that includes the target UI elements.

The data capture component 602 may also modify one or more pieces of the screen image data 614A to make the screen image data 614 in the compatible with one or more of the language models 250A, . . . ,250N and/or application models 636A, . . . ,636N. For example, the data capture component 602 may reduce the file size of the screen image data 614A so that it can be processed efficiency and accuracy by the language models 250A, . . . , 250N during training and the application models 636A, . . . ,636N during retraining and/or inference. To help make the screen image data more compatible with the language and application models, the data capture component 602 may determine a file size threshold for each of the language models 250A, . . . , 250N and/or application models 636A, . . . ,636N. The data capture component 602 may then determine a maximum pixel area for the screen image data 614A (e.g., the largest allowable area in pixel dimensions) that is within the file size threshold. For example, the data capture component 602 may determine an area of 1024 pixels by 576 pixels is the maximum allowable pixel area within the file size threshold for a language model 250A. If screen image data 614 exceeds the maximum pixel area, the data capture component 602 may remove pixels that map to the less important portions of the captured pixel area until the pixel area of the screen image data 614A is within the maximum pixel area and the file size of the screen image data 614A file is within the file size threshold.

The file size threshold for each of the language models 250A, . . . ,250N and/or application models 636A, . . . ,636N may be determined based on one or more performance metrics of each model observed at inference. For example, the if an application model 636A is taking too long to process images (e.g., has a response time that is above a response time threshold e.g., 1 minute or another pre-determined time period, for example, an application API response time set in a service level agreement (SLA) i.e., an SLA response time) or is generating responses that are not relevant to the snapshot data 520 (e.g., responses include information that is inaccurate or unrelated to the screen image data 614A, application interactions 616A, and/or context data 618A), the data capture component 602 may determine the file size of the screen image data 614 file included in the language model call is too large and may reduce the file size threshold to a value below the size of the file included in the call. The data capture component 602 may continuously monitor the performance of the language models 250A, . . . , 250N and/or application models 636A, . . . ,636N at inference to test the file size threshold. For models that are not generating responses within a desired response time and/or are generating inaccurate and/or irrelevant responses, the data capture component 602 may progressively reduce the file size threshold until the desired response time is achieved and/or the accuracy and/or relevance of the responses improves.

To reduce the file size of the screen image data 614A, the data capture component 602 may determine the most important portions of the screen image data 614A are the pixels in the top left portion of the pixel area captured in the screen image data 614A and the pixels decrease in importance further down and further to the right of the top left portion (i.e., the screenshot captured in the screen image data 614A is to be read from top to bottom and left to right so the bottom right area of the screenshot includes the least important pixels). The data capture component 602 may remove pixels in the screen image data 614A starting from the bottom right corner pixel and moving up and to the left pixel by pixel to cut off the least important portions of the screen image data 614A. The data capture component 602 may rewrite the screen image data 614A without the removed pixels to reduce the file size of the screenshot below the file size threshold.

The data capture component 602 may also collect application interactions 616A and context data 618A from the application. The application interactions 616A may include actions (e.g., clicks, selections, filters, configurations, highlights or other markings, selected dataset segments, typed text, uploaded images, and the like) performed by a user to generate the UI page that is captured in the screen image data 614A. For example, the application interactions 616A may include a selection of one or more datasets and/or data segments being shown in a graph on the captured UI page. The application interactions 616A may also include one or more competitors, brands, market verticals, customer segments, media campaigns, products and/or services, date ranges, and other configurations and/or filters selected by users within the application. The application interactions 616A may map to one or more elements of a schema for a dataset accessible by the application. For example, a application interaction 616A may be a name for one or more tables or groups of tables including data requested by the user, a description of one or more data segments being analyzed in the captured UI page (e.g., a name of one or more tables, and a name or one or more rows in a table, and the like), a period for analysis selected by the user (e.g., a date and/or date range associated with the data), a brand associated with the data analyzed in the captured UI page, one or more categories and/or subcategories of data specified by the user, and the like. The application interactions 616A may include actions that are visible in one or more screenshots included in the screen image data 614A. The application interactions 616A may also include actions performed by the user that are not visible in one or more screenshots (e.g., user selections or other actions that were input into other UI pages and/or user selections or other actions that were input into the captured UI page that are not visible in the screen image data 614A).

The context data 618A may include other data relevant to the user and/or data analyzed in the captured UI page. For example, the context data 618A may include user attributes stored in an application user profile, one or more brands and/or products associated with the user, one or more campaign ids for media campaigns run the by the user, one or more publishing channels used to deploy media campaigns, one or more key performance indicators or other performance metrics identified as goals by the user and/or measured for one or more in progress and/or completed media campaigns. The context data 618A may also include one or more consumer attributes of a target audience, consumer attributes of customers of a brand, one or more industries related to a brand, and/or one or more competitors of a brand or company. The application interactions 616A and/or context data 618A may be recorded in a structured data format (e.g., JSON, XML, YAML, and the like). The data capture component 602 may obtain the application interactions 616A and/or context data 618A from the application by sending a request (e.g., an API call) to the application interface component 210 and receiving the requested interactions and/or data in response.

The training component 240 may be used to train one or more specialized versions of the language models 250A, . . . ,250N (e.g., application models 636A, . . . ,636N) that perform specific AI system functionality within a particular application. The training component 240 may train unique application models 636A, . . . ,636N for each task requested by each application using the language model interface 220. For example, the training component 240 may train one or more insights models that generate insights and recommendations for a data analysis application. The insights model may be trained using one or more application specific training samples 620A, . . . , 620N to analyze data included in graphs and other data visualizations generated by the data analysis application. Based on this analysis, the insights model may generate one or more insights and/or recommendations requested by users of the data analysis application. The insights may identify trends and other patterns in the data and the recommendations may include one or more actions for users to take to achieve one or more goals. The training component 240 may also train one or more vision models that may assist with training the insights models. The vision models may convert the screen image data 614A captured from one or more UI pages of the data analysis application into a natural language format that may be used to train language models 250A, . . . ,250N. The vision models may generate text descriptions of graphs and other data visualizations in screen image data 614A. The text descriptions may be added to training samples 620A, . . . ,620N that are used to train the insights model.

The language model interface 220 may provide snapshot data 520 captured from an application to the training component 240. The training component 240 may use the snapshot data 520 to generate training samples 620A, . . . ,620N that are used to train application models for particular tasks. The training samples 620A, . . . ,620N may be unique for each application and may include input data 622A (e.g., features) generated from application data and/or outputs captured from the application. For example, the input data 622A for the insights model may be generated using the snapshot data 520 captured from one or more application UI pages. Training the application models 636A, . . . ,636N on application specific training samples 620A, . . . , 620N aligns the application models 636A, . . . ,636N with the specific functionalities, data formats, datasets, UI arrangements, industry context, to improve the relevance of the responses provided by the application models 636A, . . . , 636N and more closely integrate the tone, appearance, format, and content of responses with other outputs generated by the application.

The training samples 620A, . . . , 620 and/or language models 250A, . . . ,250 used to train each of the application models 636A, . . . ,636N may also be unique for each task requested by an application. Optimizing the training sample 620A and language model 250A for each task improves the precision, relevance, and responsiveness of the responses generated for each request. Optimizing the training sample 620A and language model 250A for each task also improves the compute and cost efficiency of the training process for each of the application models 636A, . . . ,636N while also improve the performance of the models during inference.

In various embodiments, the input data 622A of a training sample 620A used to train an insights model for a data analysis application may include the screen image data 614A of graphs and other data visualizations included in UI pages generated by the data analysis application. Including the screen image data 614A captured from UI pages of an application in the training sample 620A enables the insights model to learn about the datasets analyzed using the data analysis application, the graphs and data visualizations generated by the application, and the analysis tasks performed by users in the application. Training on the application specific training samples tunes the data analysis capabilities of the insights model to the datasets, tasks, and visualizations of the application that will use the model. Training on the application specific training samples also improves the precision, specificity, and quality of the insights and the relevance and actionability of the recommendations generated by insight model.

The input data 622A of the training sample 620A may also include features (e.g., application interactions features) derived from application interactions 616A that were input into an application to generate the UI page captured in the screen image data 614A. For example, the application interaction features may include one or more user selected datasets (e.g., content consumption data, visitation data, transaction data, impression data, and the like), one or more user selected audience segments (e.g., one or more target audiences, one or more target locations, one or more target transaction types, one or more target media campaigns, one or more target media channels, one or more target impression types, and the like), and one or more user selected filters for the selected datasets (e.g., one or more topic categories (e.g., recreation, services, and travel) of content tracked in the content consumption data. The application interaction features may also include one or more user selected subcategories of the selected categories (e.g., consumer services, dining, shopping, hotels, and travel regions for the selected recreation, services, and travel categories).

The input data 622A may also include features (e.g., context features) derived from context data 618A for the user selected dataset, data segments, topic categories, and/or topic subcategories. The input data 622A may also include context features for the user submitted the text generation request. For example, the context features may include one or more brands, industry verticals, products, services, competitors, and/or performance goals associated with the user. Including the application interaction features and context features in the training samples 620A aligns the insights model with the specific the user submitting the text generation request, the datasets selected by the user, and goals the user wants to the insights model to help the user achieve. Tuning the insights model to the application users, their goals, and the datasets analyzed by the application, allows the insights model to better differentiate between different application users and selected datasets to provide response that are highly specific for different users and different datasets. Generating responses that are more specific to different users and datasets increases the relevance, responsiveness, and accuracy of the insights generated by the insights model. The insights model may also be tuned on different user goals to generate recommendations that are more likely, when actioned, to achieve the specific goals of each user.

The training sample 620A may also include application and task specific training examples 624A. For example, the training examples 624A for the insights model may include example insights for graphs included in the screen image data 614A of one or more application UI pages. The training examples 624A for the insights model may also include one or more example recommendations including one or more actions to take based on the example insights. The example insights and recommendations may be specific to the data shown in the graphs captured in the screen image data 614A and may be different for each piece of screen image data 614A and each application. The example insights and recommendations may also be specific to a user and/or dataset identified in the context data 618A and/or application interactions 616A.

The training sample 620A may also include feedback data 626A for one or more insights and/or recommendations generated by the insights model. For example, the feedback data 626A may include an indication that the insights and/or recommendations were helpful (e.g., a selection of a thumbs up button or other UI element associated with positive feedback) or not helpful (e.g., a selection of a thumbs down button or other UI element associated with negative feedback) that is captured by the application. The feedback data 626A may also include comments from the user on the insights and/or recommendations that are captured as natural language text by the application. The language model interface 220 may retrieve the feedback data 626A from the application by submitting a request (e.g., API call) to the application interface component 210 and receiving the feedback data 626A in return. Including feedback data 626A in the training samples 620A, . . . , 620N enables future iterations the language models 250A, . . . ,250N and/or applications models 636A, . . . ,636N to be trained and/or retrained, respectively, based on the real world performance of prior versions of the models. Language models 250A, . . . ,250 may be trained using generated responses (e.g., generated insights and recommendations) from previously released application models 636A, . . . ,636N as training examples 624A and feedback on the generated response as feedback data 626A to improve the performance of new application models 636A, . . . ,636N. Previously trained application models 636A, . . . ,636N may also be continuously retrained using responses generated by the application models 636A, . . . ,636N as training examples 624A and feedback collected for the generated responses as feedback data 626A to improve the performance of the application models 636A, . . . ,636N over time and improve the accuracy, relevance, and usability of the responses generated by the models.

The feedback data 626A may also be used to determine the feature sets that may be included in the training samples 620A, . . . , 620N. For example, the training components 240 may generate a training sample 620A for an insights model that includes example insights and example recommendations having positive feedback data 626A. To generate the training sample 620A, the training components may identify the insights and recommendations generated by a previously released version of the insights model that received positive feedback data 626A. The each identified example insight and recommendation along with the features included in the user prompt used to generate each of the insights and recommendations (e.g., the image features, the application interactions features, and the context features) may be combined into a feature set of the positive example. The training components 240 may continue to generate a training sample 620A including feature sets for positive examples until a training threshold is reached (50 examples, 100 examples, 1000 examples, and the like). When the number of feature sets in the training sample 620A meets or exceeds the training threshold, the training components 240 may generate a training file including each of the feature sets and use the training file to train a new version of the insights model and/or retrain a previously released version of the insights model. The training components 240 may also be programmed to train and/or retrain an insights model periodically on predetermined schedule (e.g., daily, weekly, monthly, etc.). For scheduled training/retraining, the training components 240 may generate a training file that includes all of the feature sets generated for positive examples received since the last training/retraining job. The training components 240 may then use the training file including the feature sets generated for new positive examples to train and/or retrain an insights model.

To train application models 636A, . . . ,366N for a particular application, the training component 240 may generate training samples 620A, . . . ,620N that incorporate screen image data 614A, application interaction features, and/or context features from snapshot data 520 captured for one or more UI pages generated by the application. A prompt generator 628 may generate a training prompt for each of the training samples 620A, . . . ,620N and the training prompts may be arranged in a training file. The training component 240 may then display a training portion of the training prompts in the training file to a language model 250A selected by the model selector 632 to train the application model 636A for the application. The training component 240 may then display a test portion of the training prompts in the training file the trained language model 250A to validate the model performance and/or update one or more model parameters. After testing, trained language models 250A that achieve a desired level of performance may be stored as application models 636A, . . . ,636N that may be inferenced to generate responses to text generation requests received by the language model interface 220.

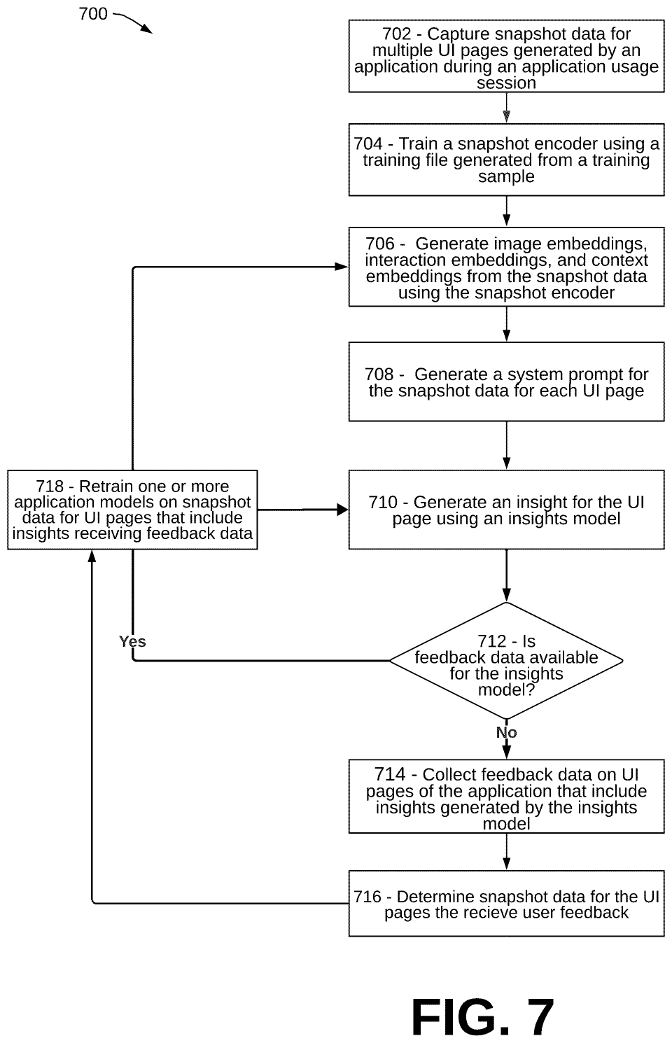

FIG. 7 illustrates more details of a process 700 for training the application model. At step 702, the data capture component may capture snapshot data for multiple UI pages generated by an application. For example, the data capture component may capture snapshot data for generated UI pages that are displayed to a user during an application usage session. An application usage session may be the time period a user actively interacts with an application after opening it. The session may begin when a user opens that application and end when the application goes into the background or after a predefined period of inactivity (e.g., 30 minutes or other predefined time period). The multiple UI pages may represent different application states at various positions of workflows performed in the application. For example, the data capture component may capture snapshot data for multiple UI pages of a data analysis application. The snapshot data may capture the state of the application at multiple stages of a data analysis workflow used to generate a graph for a user selected dataset. For example, the snapshot data of a data selection UI page may capture a data selection state of the application following the selection of a dataset by a user, snapshot data of a graph configuration UI page may capture a graph configuration state of the application following the selection of one or more graph configurations by the user, and snapshot data of a report UI page may capture a report display state of the application following the generation and display of a report including the graph configured by the user.

The data capture component may capture snapshot data for multiple instances of the same type of UI page. For example, the data capture component may capture UI pages for the same stage of the workflow during different application usage sessions. The data capture component may capture UI pages for the same user at different times and/or different users and different datasets. The UI pages for each user and/or dataset may have different objects included in the screen image data (e.g., different text, different input data, different output data, different visualizations, different graph types, different graph formats, different reports, and the like). The snapshot data for each UI page may also having different application interaction data (e.g., different uploaded datasets, different selected data segments, different filters, different cursor paths, different hover times, different interactions with UI elements, different configurations, and the like) and/or different context data (different user types, different industries, different products, different brands, different competitors, different marketing channels, different types of impression data, different user goals, and the like). The data capture component may also capture snapshot data for UI pages in multiple workflows (e.g., the UI pages for each stage in a graph analysis workflow, data enrichment workflow, data segmentation workflow, and the like). Capturing snapshot data for a wide range of UI pages ensures the snapshot data is both wide (e.g., captures the state of the application at every position of every possible workflow) and deep (e.g., captures multiple instances of each application state in each position of all workflows).

The snapshot data may include screen image data of the UI page displayed by the application, the application interaction data including recorded application interactions with the application performed to configure the application into an application state that causes the UI page to be generated, and context data about the dataset, user, and/or task being performed in the application. For example, the snapshot data for a report display UI page may include screen image data of one or more graphs included in the report displayed in the UI page. The snapshot data may also include application interaction data including application interactions that cause the application to generate the report such as, for example, a selection of a dataset, a selection of a data segment, a selection of one or more filters applied to data (e.g., categories within the selected data segments, date ranges of interest, and the like). The snapshot data for the report display UI page may also include other application interaction data such as one or more user selected configurations for the graphs included in the report including, for example, a type of graph, one or more datasets or data segments to include in the graph, and context data relevant to the user generating the report and the data shown in the graphs.

At step 704, the training component may train a snapshot encoder using a training file generated from a training sample. The trained snapshot encoder may determine one or more embeddings from the snapshot data (e.g., one or more image embeddings representative of a portion of the screen image data, one or more interaction embeddings representative of a portion of the application interaction data, and one or more context embeddings representative of a portion of the context data). In various embodiments, the snapshot encoder may include a separately trained encoder for each dataset. For example, an image encoder that generates image embeddings from the screen image data, an interaction encoder that generates interaction embeddings from the application interaction data, and a context encoder that generates context embeddings from the context data. The training sample for each encoder may be specific to the application generating the UI pages captured in the snapshot data. For example, the training component may generate application specific image training samples used to train an image encoder configured to determine numerical embeddings that encode a portion of screen image data of graphs generated by a data analysis application. The image training samples for the data analysis application may include screen image data of a portion of a UI page generated by the data analysis application that includes a graph. The image training samples may also include image embeddings determined for each piece of screen image data of the UI page, text description generated for each of the image embeddings, and feedback data received for an insight generated for the snapshot data of the UI page.

The training component may also generate insights training samples for training an insights model. The insights training samples may also be unique to each application. For example, the training component may generate an insights training sample that is specific to the data analysis application. The trained insights model may be a language model that generates natural language insights and recommendations for the UI pages captured in the snapshot data. For example, the insights model may generate a natural language description of one or more trends or patterns identified in a graph included in snapshot data of a report UI generated by the data analysis application. The insights model may also generate a natural language description of one or more follow up actions to take based on the identified trends or patterns. The follow up actions may include actions to perform in the data analysis application (e.g., generate a graph for another audience segment to determine if the identified pattern is consistent across multiple segments) or other applications connected to the insights model (e.g., modify the creative for a campaign id targeting the audience segment should in the report UI). The insights training samples may include a system prompt determined for the snapshot data, natural language insights generated by the insights model for the snapshot data, and feedback data recorded for actions performed based on the generated insights. The system prompt may include natural language description generated for the snapshot data (e.g., a text description generated for the image embeddings determined by the image encoder, a text description for the interaction embeddings determined by the interaction encoder, and a text description of context embeddings determined by the context encoder.

The training components may train the snapshot encoder and the insights model using training file generated from the training samples. In various embodiments, to train the snapshot encoder the training components may train one or more sub-models within the snapshot encoder (e.g., the image encoder, interaction encoder, context encoder, a fusion encoder, snapshot description language model, and the like). The training components may include a model selector that may select one or more models (e.g., one or more general purpose language models) to train using the model specific training files. The model selector may select the models to train based on one or more characteristics of the models and/or the application using the trained model. For example, the model selector may select language models based one or more model characteristics (e.g., file size, number of trainable parameters, latency, training cost, inference costs, and the like) that may be compatible with the application and/or one or more application characteristics (e.g., a subject matter expertise of the model, one or more requirements of the application, for example, low cost, high accuracy, low latency, and the like, task expertise of the model, relevance of the dataset used to pre-train the models, and the like) that may align with the language model. For example, the model selector may select a language model having low latency and low inference costs for training an insights model used by a data analysis application that processes low risk data (e.g., marketing data) and has a fast response SLA requirement (e.g., report generation in less than 1.5 seconds).

Feedback data received for insights generated by the insights model may also influence the models that are selected for training. For example, if feedback data indicates an application model constructed using a particular language model is performing well in an application (e.g., the performance of the application model exceeds a performance threshold for one or more metrics, for example, at least 80% of the feedback received is positive), the same language model may be trained for use in other application models for the application and/or other applications that have similar AI system functionality (e.g., use language models to perform similar tasks, generate similar responses, respond to similar text generation requests, and the like). If the feedback data indicates the application model is not performing well in an application (e.g., the performance of the application model is below a performance threshold), the model selector may select a different language model to training for use in new application models for the application and/or other applications with similar AI system functionality.

The training component may generate application models that are specific to different types of applications. The application models may be a version of an insights model specialized to provide insights that may be used within different types of application. For example, the insights model for the data analysis application may be an analysis application model. The training component may condition each version of the insights model using an agent prompt that configures the trained model as a particular type of application model and instructs the model to perform one or more tasks. For example, the agent prompt for the insights model for the data analysis application may configure the model as a data analyst that identifies patterns and trends in data and draws insights from the identified patterns and trends.

The training components may generate training prompts that train a language model to perform in the tasks included in the instructions of the agent prompt. The task specific training on the training prompts may improve the ability of the language models to perform each instructed task by tuning the model parameters based on example responses included in the training prompts. The training components may also generate training files for training one or more sub-models of the snapshot encoder. For example, the training component may generate an image training file that includes, screen image data for a UI page included in snapshot data, one or more image embeddings determined for the screen image data, a natural language description of the portion of the screen image data represented by each embeddings, and feedback data received from one or more insights generated for the UI snapshot. The image training file for training the vision model may include one or more image training features generated from the snapshot data. The image embeddings may be determined by mapping the screen image data to an image embeddings space trained on previously captured screen image data for a sample of UI pages (e.g., UI pages from a specific application, UI pages from many different applications, UI pages generated by a particular user, UI pages including a particular type of image content, and the like). The natural language description may include a description of the objects visible in the portion of the UI page. The training data for each UI page training sample may be aggregated to generate a training file used to train the image encoder.

The training files may include a training portion and a testing portion. For training files used to train language models, he training prompts in the training and testing portions may be formatted to be received by the language model selected for training and the trained application model, respectively. The training files used to train the sub-models of the snapshot encoder may include a set of training features (e.g., screen image data, image embeddings, embedding descriptions, and feedback data) for each training sample in the training portion. The testing portion may include a set of testing features (e.g., screen image data, image embeddings, embedding descriptions, and feedback data for a second sample of UI pages that were included in the training file that were not selected for the training portion). The UI pages selected for the training portion may be different from (e.g., not included in) the UI pages selected for the testing portion so that the application model will not be exposed to the training features during testing. The training components may generate the training features and the testing features using the snapshot data captured for an application to generate a unique training file for each application.

To use the training file to train the image encoder, the screen image data may be input into the encoder. The embedding layers of the image encoder may generate image embeddings for each piece of screen image data my mapping the image data to an image embeddings space. The image embeddings output by the embedding layers may be transmitted to the text encoding layers that may generate a natural language description of the image features included in the portion of the screen image data represented by the embeddings by mapping the embeddings to a text embedding space. During training, the weights and/or parameters of the image embedding space generated by the embedding layers and the weights and/or parameters of the text embeddings space generated by the text encoding layers may be modified based on the feedback data received for the insight generated for each UI page so that the image embeddings and natural language descriptions generated for UI pages that received positive feedback for generated insights are more emphasized in the training data. Modifying one or more aspects of the image embedding space and/or text embeddings space based on the feedback data, train the language model to recognize visual features in the screen image data of the application UI pages that have actionable trends and/or patterns, understand the vocabulary the user of the application prefers to use to describe the application UI elements, data, objects, and tasks that are most common in the application, understand the insights and patterns in the datasets included in the screen image data that are most important to the user, and, understand the tone, vocabulary, and language structure that resonates with the user when describing the trends and patterns and recommending the insights. The image encoder may be generated by incorporating modifications to the image embedding space, text embeddings space, and/or mappings between the image embedding and text embedding spaces into the image embedding layers, text embeddings layers, and connecting layers of the image encoder.

The image encoder may be tested using the testing portion of the training file to determine if the training on the training portion was effective. The image encoder may be tested by inputting screen image data for a UI page in the testing portion of the training file into the image embedding layers to generate image embeddings. The generated image embeddings may be provided to the text embedding layers to generate natural language descriptions for the screen image data. A score (e.g., a similarity score, for example, cosine similarity) for each test text description may be determined by comparing the generated natural language description for the image embeddings to the example natural language descriptions in the training file that was pre-generated for the image. To determine the cosine similarity, the text of the test description and the example description may be converted into a numerical vector representation using a text encoder (e.g., an encoder model implementing a text to vector algorithm (e.g., bag-of-words, tf-idf, and the like) and/or the portion of the image encoder used to calculate word embeddings (e.g., the text embedding layers). The cosine similarity between the output response vector (e.g., test description vector) and the example response vector (e.g., example description vector) may be calculated. A performance score for the image encoder may be determined by aggregating the similarity scores determined for each test natural language description. The performance score may be compared to a performance score threshold to test the image encoder. If the performance score for the image encoder meets or exceeds the performance score threshold, the image encoder may be deployed to production and made available for inference. If the performance score for the image encoder is below the performance score threshold, the image encoder may be retrained based on at least one of the performance score, the test natural language descriptions, the original training file, and a new image training file until the performance score for the retrained version of the vision model meets and/or exceeds the performance score threshold.

The training components may similarly train the other sub-models of the snapshot encoder. For example, the interaction embedding layers and text embedding layers of the interaction encoder and the context embedding layers and text embedding layers of the context encoder may also be trained based on the feedback data received for insights generated for the snapshot data of the UI pages. The weights and/or parameters of the interaction embedding space and text embedding space of the interaction encoder may be modified based on the feedback data to emphasize the interaction embeddings and natural language descriptions generated for snapshot data of UI having insights that received positive feedback more in the training data. Similarity, weights and/or parameters of the context embedding space and text embedding space of the context encoder may be modified based on the feedback data to emphasize the context embeddings and natural language descriptions generated for snapshot data of UI having insights that received positive feedback more in the training data. The interaction encoder and context encoder may also be validated based on a comparison of the natural language descriptions of the respective interactions and context data generated by the trained encoders to their corresponding example natural language descriptions in the testing portion of the training file.

The system prompt may be a natural language prompt for a language model generated by fusing three coordinated signals derived from an application usage session (e.g., image embeddings determined from screen image data of a UI page, interaction embeddings determined from recorded application interactions during the application usage session that produced the UI state captured in the screen image data, and context embeddings determined from profile data for the user, brand, and/or product associated with an application usage session. The snapshot encoder may execute an encoding pipeline that transforms raw multimodal inputs into a structured prompt that constrains a language model to produce natural language insights that are specific to the UI page captured in the snapshot data.

To generate the system prompt, the data capture component may capture screen image data (e.g., a pixel-level data for one or more screenshots) of the UI page rendered during the session. The data capture component may also collect application interaction data for an application usage session. The interaction data may include telemetry data for an application usage session that identifies user events (e.g., clicks, hovers, scrolls, text inputs, dwell times, navigation, and error events) and page/application metadata (e.g., DOM identifiers, component coordinates, locale, device form factor, and experiment arm). The data capture component may also capture context data associated with the application usage session. The context data may include user attributes stored in an application user profile (e.g., declared preferences, user location, language, one or more brands and/or products associated with the user, one or more campaign ids for media campaigns run the by the user, one or more publishing channels used to deploy media campaigns, one or more key performance indicators or other performance metrics identified as goals by the user and/or measured for one or more in progress and/or completed media campaigns, and the like. The context data may also include one or more consumer attributes of a target audience, consumer attributes of customers of a brand, one or more industries related to a brand, and/or one or more competitors of a brand or company profile data. The context data may also include brand or product profile data for any campaign referenced by, or associated with, the application usage session (e.g., tone and style descriptors, brand creative style guides, brand trademarks and/or trade dress, and the like).

The screen image data, application interaction data, and context data collected by the data capture component may be normalized and transformed into a structured data format that is specific to each modality. For example, the data capture component apply optical character recognition and UI element detection to the screen image data to generate structured descriptors (e.g., bounding boxes, component types, and extracted on-screen text) while masking or blurring selected regions of image data (e.g., portions of the image that content personally identifiable information or other sensitive fields) prior to encoding. The data capture component may also preprocess the application interaction data by, for example, aligning interaction event timestamps to the screenshot time, resolving interaction events to specific UI elements via spatial or identifier matching, and deriving temporal features such as recency, frequency, dwell, hesitation, back-tracking, and scroll depth from the timestamp data, telemetry data, and screen image data. For the context data, the data capture component may compile a machine-readable representation of user profile attributes and brand and/or product profile attributes. The data capture component may then aggregate the preprocessed screen image data, application interaction data, and context data into snapshot data for each captured UI page.

At step 706, a trained snapshot encoder may generate image embeddings, interaction embeddings, and context embeddings from the snapshot data. In various embodiments, a modality specific sub-model, may encode each data modality into a dense vector representation. For example, a image encoder (e.g., a convolutional or transformer-based image model) may generate a global screen embedding and/or one or more region-level embeddings for areas of the image that include important UI elements and/or UI elements that include more information. For example, the image encoder for the data analysis application may generated multiple regional-level embeddings for the portion of screen image data that includes a graph other visualization. An interaction encoder (e.g., a recurrent, temporal-convolutional, or transformer model) converts the application interaction events into an interaction embedding that captures intent and friction patterns observed in the application usage session. A context encoder generates a context embedding from user profile attributes and brand/campaign artifacts extracted from product and/or brand profiles. In some implementations, the context encoder may determine user and brand sub-embeddings for context data extracted from user profiles and product and/or brand profiles, respectively. The user and brand sub-embeddings may be concatenated and projected to a unified context vector. Each embedding generated by the image encoder, interaction encoder, and context encoder may be projected through learned heads to a shared latent space and L2-normalized to facilitate downstream fusion and retrieval operations.

A fusion sub-model included in the snapshot encoder may generate a single global encoded vector for the snapshot data by combining the image, interaction, and context embeddings with learned weights. In one implementation, the fusion model may include a gating module that may compute non-negative mixture coefficients for the three embedding modalities based on their content and quality. The gating module may determine calculate the global encoded vector by calculating the weighted sum of the normalized embeddings. In another implementation, the fusion model may include a cross-attention module that relates region-level image embeddings to UI element-level interaction embeddings to identify the K most consequential on-screen regions (e.g., a graph of a report UI page, a data selection dropdown of a graph configuration UI, and the like) that should be explicitly summarized in the natural language descriptions for the global vector, thereby aligning what the user saw with what the user did.

The snapshot encoder and/or applicable sub-model may generate natural language descriptions of each global encoded vector and/or each embedding modality. The natural language descriptions may be generated by mapping the embeddings to a trained text embedding space. The image embedding descriptions may describes the important visual elements of the screen image data and any OCR-extracted text (for example, product name, campaign id, target segment, price, graph configurations, visible call-to-action labels, warnings, and the like). The image embedding descriptions may also include natural language descriptions of a subset of visual components ranked most relevant by the fusion sub-model. The application interaction descriptions may describe a user's recent path and focus (for example, opened size guide, hovered discount terms, changed size twice, scrolled to reviews to 30%, paused near Add to Cart and the like). The context descriptions may describe the persona and tone constraints for a user and/or brand.

At step 708, the snapshot encoder may generate a system prompt for the snapshot data for each UI page. The system prompt may include multi-part instructions configured for the particular language model used to implement the insights model. A system block of the system prompt may states role and guardrails for the insights model (e.g., “do not invent unavailable facts, respect brand tone, and include mandatory disclaimers”). A context section may embed one or more snapshot features of the UI page. The snapshot features may include the natural language descriptions of the image embeddings, interaction embeddings, and context embeddings. A task section of the system prompt expresses the specific objective and output schema (e.g., “generate insights relevant to the UI page; insights should identify 1-2 patterns or trends in the graph shown in the image data and recommend a follow up action to take based on the identified trend that will increase the engagement rates for a content campaign”). The system prompt may also include a constraints section that specifies tone adjectives, banned terms, jurisdictional restrictions, required phrases, maximum lengths, and the desired output format (for example, a strict JSON schema). The system prompt may also includes a few-shot positive examples including the snapshot features and prior generated insights that received positive feedback data and/or a few-shot negative examples including snapshot features and prior generated insights that received negative feedback data.

The system prompt may be provided to an insights model that may generate one or more natural language insights for the UI pages captured in snapshot data. The training components may use one or more system prompts to generate training samples for one or more language models. The insights training sample may include the snapshot features determined from the snapshot data for multiple UI pages of an application, prior generated natural language insights generated by the insights model, and feedback data received for one or more generated insights.

In various embodiments the snapshot features may include the image features for each UI page may include screen image data capturing a portion of the UI page and a natural language description of the screen image data generated by the vision model. The application interaction features generated from the application interactions performed to generate the UI page and context features generated from context data for one or more users and/or datasets that are related to the UI page. For example, the context features may be generated by a context encoder that encodes one or more pieces of context data (e.g., one or more brands, industries, competitors, and the like) associated with one or more users that generated the UI page and/or one or more pieces of context data (e.g., one or more products, campaigns, geographic locations, media channels, and the like) associated with one or more datasets shown in a graph or other object displayed in the UI page into a format (e.g., natural language and/or structured (e.g., JSON, XML, structured text, and the like) format) that may be input into a language model. The snapshot features may also include an example insight and an example recommendation generated for one or more graphs or other objects captured in the screen image data. A text encoder may be used to encode the example insights and/or example recommendations into a format that may be may (e.g., natural language and/or structured (e.g., JSON, XML, structured text, and the like) format) that may be input into a language model and the encoded insights and/or recommendations may be added to the snapshot features.

The snapshot features determined for each UI page may be combined to generate an insights feature set for a UI page. The insights feature sets generated for the UI pages in the insights training sample may be added to an insights training file. At step 710, the training components may use the insights training file to train an application insights model. To train the application insights model, an application selector may select a language model for training based on one or more model and/or application characteristics as described above. The training components may generate a system prompt that configures the selected language model as a particular type of application model. The system prompt may also include instructions for the the application model to perform one or more tasks. For example, the system prompt for the insights model may configure the selected language model as a marketing image analyzer that generates one or more insights and one or more recommendations for data displayed in a graph or other object captured in the screen image data. The training components may generate training prompts to train the language model configured by the system prompt to perform the task included in the system prompt instructions. The training prompts may be input into the configured language model to improve the ability of the model to perform a task (e.g., improve the responses generated by the model).

To generate the training prompts, the training components may divide the insights feature sets (e.g., the image features including screen image data and text description of the image data), the application interaction features, context features, example insights, and feedback data included in the insights training file into a training portion and a testing portion. The training components may generate one or more insights training prompts that include an insights feature set in the training portion of the training file. The insights training prompts may be formatted to be received by the configured language model and the training prompts may input each feature in the feature set to the configured language model. The configured language model may generate based on at least one of the image features (e.g., screen image data and text description of the image data) and the application interaction features, context features, example insights, and feedback data)), an output response that is used to train the model. The training components may modify one or more trained parameters of the model feature space, text embedding space, and/or mappings between the model feature space and text embedding space of the selected language model based on one or more of the snapshot features, and the output response to train the configured model. The insights model may be generated by incorporating the modifications to the model feature space, text embeddings space, and/or mappings between the model feature and text embedding spaces into the configured language model.

Modifying one or more aspects of the configured language model based on the features in each training prompt may train the language model to generate a text response to one or more text generation requests received by the language model interface. For example, a UI page of an application may generate a text generation request to generate a text output (e.g., an insight and/or recommendations) associated with one or more objects (e.g., a graph including one or more segments of a dataset) displayed on the UI page. Snapshot features for the UI page may be input into the insights model that is configured to analyze data displayed in graphs and other objects included in the screen image data of the UI page, draw, based on the analysis, one or more insights that are relevant to the context features for a particular user and/or dataset, and generate one or more recommendations based on the insights that can be actioned by the user to achieve one or more user specific goals included in the context features. Training on the application specific insights feature sets generated from application UI pages may ensure the insights and recommendations are relevant to the users of the application and the datasets processed by the application. Training on the application specific insights feature sets may also improve the usability of the insights and recommendations by aligning the outputs of the insights model with the example insights and recommendations, application interaction features, and context features included in each feature set.

The insights model may be tested using the testing portion of the insights training file to determine if the training on the training portion was effective. To test the insights model, the training components may generate an insights testing prompt for each feature set in the testing portion. The insights testing prompt may include a testing insights feature set determined from the insights feature sets in the test portion. To generate the testing insights feature set, the example insight and example recommendation may be removed from each insights feature set in the testing portion so that the insights model can generate the test insights and test recommendations independently. The insights testing prompt may also include instructions for the insights model to generate one or more insights and one or more recommendations based on the testing insights features. The testing insights prompts generated for each of the feature sets in the testing portion may have a format (e.g., natural language and/or structured (e.g., JSON, XML, structured text, and the like) format) that may be input into a language model. The training components may input each of the testing insights prompts into the insights model. An output text response (e.g., a test insight response) including one or more insights and one or more recommendations may be generated by the insights model for each testing insights prompt based on at least one of the instructions and features (e.g., snapshot features) included in the insights testing prompt. A score (e.g., a similarity score, for example, cosine similarity) for each output text response may be determined by comparing the test text response generated for each testing insights feature set to the corresponding example response (e.g., example insights and recommendations) for the insights feature set included in the training file. To determine the cosine similarity, an encoder (e.g., a text encoder implementing a text to vector algorithm (e.g., bag-of-words, tf-idf, and the like) and/or the aspects of the insights model that calculate word embeddings for input text) may encode the text of the test text response and the example response for each insights feature set as a numerical vector representation. The cosine similarity between the test text response vector (e.g., the output response vector) and the example response vector may be calculated. A performance score for the insights model may be determined by aggregating the similarity scores determined for each test response and the performance score may be compared to a performance score threshold. If the performance score for the insights model meets or exceeds the performance score threshold, the insights model may be deployed to production and made available for inference. If the performance score for the insights model is below the performance score threshold, the insights model may be retrained based on at least one of the performance score, the test text responses, the original insights training file and new insights training file until the performance score for the retrained version of the insights model meets and/or exceeds the performance score threshold.

To improve the responses generated by the application models, the training components may also modify the system prompts used the configure the language models to include one or more response guidelines. The response guidelines may include additional instructions for the application models to follow when generating responses and different response guidelines may be used for different application models. For example, the response guidelines for an insights model used to generate insights and recommendations for marketing datasets may include format guidelines, exclusion guidelines, brand guidelines, customer guidelines, and analysis guidelines. Table 1 below illustrates examples of each type of response guideline for the insights model.

TABLE 1

| Guideline Type | Example Instructions |
|---|---|
| Format | “Output shall not exceed 150 words” |
| | “Start insight with ‘The data indicates that’” |
| | “Use ‘industry average’ instead of ‘network baseline’” |
| Exclusion | “Do not mention aspects of the image that align with |
| | the brand's positioning” |
| | “Do not use any numbers or percentages shown in the |
| | image in your analysis or in the output.” |
| Brand | “You may mention other brands and media |
| | partnerships that are extremely relevant” |
| | “The insight and recommendation should focus on how |
| | the brand can acquire new customers, prevent existing |
| | customer churn or upsell or cross sell other products or |
| | services that are currently offered by the brand” |
| Customer | “You may also provide relevant recommendations |
| | based on any life events or specific needs of the |
| | customers” |
| Analysis | “You may suggest marketing campaign strategies |
| | where return on the ad spend can be clearly measured” |
| | “You can consider any entry that crosses the network |
| | baseline as something that is indexing high for that |
| | customer segment and vice versa” |

The format guidelines may control the length, word choice, style, tone, and/or appearance of the application model responses to make the responses more consistent across different users and different requests. The exclusion guidelines may eliminate certain types of content from the responses to avoid confusing the model and the user. The exclusion guidelines may also improve the relevance of the responses by eliminating irrelevant data that may appear in the user prompt. The brand guidelines may focus the attention of the application model on one or more brand characteristics and/or brand objectives included in the context features and/or inferred from the application interaction features. The customer guidelines may focus the attention of the application model on one or more customer characteristics that are included in the context features and/or inferred from the data in the graphs or other objects captured in the screen image data. The brand and customer guidelines may improve the relevance and usefulness of the application responses by specifically tailoring the content of each response to the data in the graphs or other objects capture in the screen image data and the user receiving each response. The analysis guidelines may help the application model interpret specific metrics and/or provide one or more seeds to facilitate generating specific types of responses.

If the performance score for the insights model is below the performance score threshold, the training components may add one or more response guidelines to the test user prompt. The performance score for the insights model may be determined based on the new test responses generated by application models configured using the updated system prompts to determine if the response guidelines helped to improve the test responses. Response guidelines that improve the performance score of the insights model may be included the system prompts for configuring language models and/or application models for new tasks and/or applications.

Referring back to FIG. 6, the trained application models 636A, . . . ,636N (e.g., the vision model, the insights model, and the like) may used by one or more agentic applications 634 to perform tasks received by the language model interface 220. The agentic applications 634 may include one or more application agents that use the application models 636A, . . . , 636N to generate responses for tasks received for applications connected to the language model interface. The application agents may perform tasks by using one or more tools included in the agentic application to complete subroutines (e.g., action chains). The tools may be, for example, utilities, APIs, API wrappers, shells or terminals that execute commands written in a computer language (e.g., Python, Node.js, SQL), and the like. The tools may also provide an interface that enables the application models 636A, . . . , 636N selected by the application agents to interact with resources to perform a task and/or complete an intermediate step (e.g., extract data, make a calculation, make a decision, execute a program, and the like) of a subroutine. The tools may enable the application models 636A, . . . ,636N to interact with a wide variety of resources including, for example, data sources (e.g., relational databases, unstructured databases, identity graphs, document stores, and the like), software packages (e.g., applications, computer programs, executable files, executable programs, scripts, programs, code repositories, code libraries, and the like), content libraries (e.g., repositories of images, videos, audio files, and other content), and models (e.g., machine learning models, language models, generative AI, and other models that may generate predictions, make decisions, draw insights, perform data analysis, and generate other data).

The agentic applications 634 may also include one or more orchestration components that are used to run one or more plan and execution cycles required to complete subroutines. During each plan and execution cycle, the orchestration components may generate an agent call (e.g., a call to a language model) for an application agent. The agent call may include a user prompt formatted for the application model 636A, . . . ,636N selected by the application agent, a mapping between a task and/or intermediate step included in the user prompt, a tool that may be used to complete the task and/or intermediate step, and a software script for evoking and running the tool.

To respond to a text generation request received by the language model interface 220, such as, for example, generate an insight and recommendation, the training component 240 may generate a system prompt that configures an agentic application 634 as a marketing agent for analyzes marketing data. The system prompt may include natural language instructions that define the role of the marketing agent (e.g., analyze images displaying marketing data) and provide one or more tasks for the marketing agent to perform (e.g., generate one or more insights and/or recommendations for data included a graph or other object captured in a piece of image data). The marketing agent (e.g., the agentic application 634 configured as the marketing agent) may receive a user prompt including one of more insights features generated from a piece of snapshot data 520 captured from the application generating the text generation request. The marketing agent may interpret the prompt, identify a piece of image data (e.g., screen image data 614A) in the insights features, and determine two actions are required to perform the insights and recommendations generation task (e.g., generate vision features for the screen image data and analyze the vision features and the insights features to generate the insights and recommendations). To complete the first action, the orchestration components of the marketing agent may generate a first agent call that delegates an image translation action to a vision agent. The first agent call may include a user prompt that provides the screen image data 614A and the image translation action for the vision agent to complete (e.g., generate image features for a piece of input image data that include a natural language description of the data included in a graph or other object shown in the input image data). The user prompt of the first agent call may also include and one or more response guidelines for the image translation action (e.g., one or more format guidelines that instruct the vision agent to format the description in natural language, format the response including the description in one or more machine readable formats (e.g., JSOM, XLM, and the like), limit the length of the description to 250 words, and the like). The first agent call may also include a mapping between the image translation action and the vision model. The first agent call may also include one or more lines of computer code (e.g., a software script) for invoking and using the tool to complete the action and/or intermediate step. For example, the first agent call may include an invocation script that may be used to access the vision model and a prompting script that may be used to generate a user prompt formatted for the vision model that provides the screen image data, instructions for completing the image transaction action, and the response guidelines to model. The vision agent may run the scripts to interact with the vision model to generate image features (e.g., a natural language description) for the screen image data. The orchestration components of the marketing agent may add the natural language description of the screen image data generated by the vision model to the set of insights features for the screen capture 612A.

Once the set of insights features has been updated, the orchestration components of the marketing agent may generate a second agent call that delates the second step of insights and recommendations generation task to an analyst agent. The second agent call may include a second user prompt that instructs the analyst agent to perform the second action of the task (e.g., generate one or more insights and one or more recommendations for the insights features generated for the snapshot data 520 of the screen capture 612A). The second agent call may also include a mapping between the second action and the insights model and a script for invoking the insights model and interacting with the model to generate the insights and recommendations. The analyst agent may use the scripts to generate a user prompt for the insights model that formats the updated set of insights features for the insights model. The user prompt may also include instructions to perform the insights and recommendations action and one or more response guidelines for the insights model to use to generate a response. The analyst agent may use the scripts to interact with the insights model by displaying the user prompt to the model and receive a response from the insights model in return that includes the generated insights and recommendations. The orchestration components may generate a third agent call that causes the marketing agent to associate the insights and recommendations with a context id that corresponds to the screen capture 612A and/or user receiving the insights and recommendations. The third agent call may also cause the marketing agent to store the generated insights and recommendations associated context id in memory (e.g., in an insights cache 640) and provide the insights and recommendations to the application interface component 210 for in a UI page of the application submitting the text generation request.

To perform each intermediate step and/or action of a task, the application agents may submit agent calls to different application models 636A, . . . ,636N. The application agents may execute one or more plan and execution cycles for each intermediate step and/or action, and the application agents may select one or more application models 636A, . . . ,636N to use for each cycle. During the plan phase of the cycle, the application models 636A, . . . ,636N selected by the application agents may interpret the prompt included in the agent call to determine a next action and/or intermediate step to perform. For the execution phase, the application models 636A, . . . , 636N may generate responses for each call that are used to complete each action and/or intermediate step. The application models 636A, . . . ,636N may also use the tool mappings and scripts in the agent call to locate and interact with the one or more tools to operate resources and perform actions and/or intermediate steps. The selected application models 636A, . . . ,636N may generate a response including one or more outputs generated using the resources. The application agents may receive the responses and include them in the next agent call for the next intermediate step. For example, the application agents may include a response generated for a first agent call in an second agent call for an agent that determines the next action and/or intermediate step required to perform a task. The application agents may also include the response for a first agent call in a second agent call for an agent that may use and/or transform one or more outputs in the response to complete an action and/or intermediate step. The plan and execution cycles for different agentic applications 634 may have different requirements that suit application models 636A, . . . ,636N with different performance characteristics and capabilities. For example, plan and execution cycles may involve different tools and different types of tasks that fit application models 636A, . . . ,636N having a particular training sample 620A, . . . ,620N and/or performance profile.

Referring back to FIG. 7, insights and recommendations generated using the insights model may be provided to an application by the language model interface and displayed in the application. The application may be configured to collect feedback on the insights and recommendations. For example, the application may have a UI element (e.g., thumbs up button, thumbs down button) that enables users to enter feedback data. The application may also track instances where the users took an action recommended by one of the generated recommendations. At step 712, the language model interface may request feedback data for the generated insights and/or recommendations collected by the application. If the application has collected feedback data on one or more insights and/or recommendations (Yes at step 712), the one or more of the application models (e.g., the vision model and/or the insights model) may be retrained using a training sample including the insights and recommendations receiving feedback data and other features generated from the UI pages that display the insights and/or recommendations. For example, the vision model may be retrained using a vision retraining file that includes image features (e.g., image, description pairs) generated from screen image data of the UI pages receiving feedback. The insights model may be retrained using an insights retraining file that includes features (e.g., image features, application interaction features, and/or context features) determined based on the snapshot data generated from the UI pages receiving feedback. During retraining, the cosine similarity scores for feature sets determined for UI pages receiving positive feedback may be added to the performance score to use the positive feedback to reinforce the model. The cosine similarity scores for the features sets determined for UI pages receiving negative feedback may be subtracted from the performance score to penalize the model for generating responses that are similar to insights and/or recommendations receiving negative feedback.

If the application has not collected feedback data (No at step 712), the application may continue to use the original version of the application models to generate insights and recommendations. At step 714, the application may collect new user feedback on one or more UI pages that include insights and/or recommendations generated by the insights model. At step 716, the data capture component may capture snapshot data of the UI pages that received the user feedback and the new captured snapshot data may be used to generate feature sets that are used to retrain one or more of the application models at step 718.

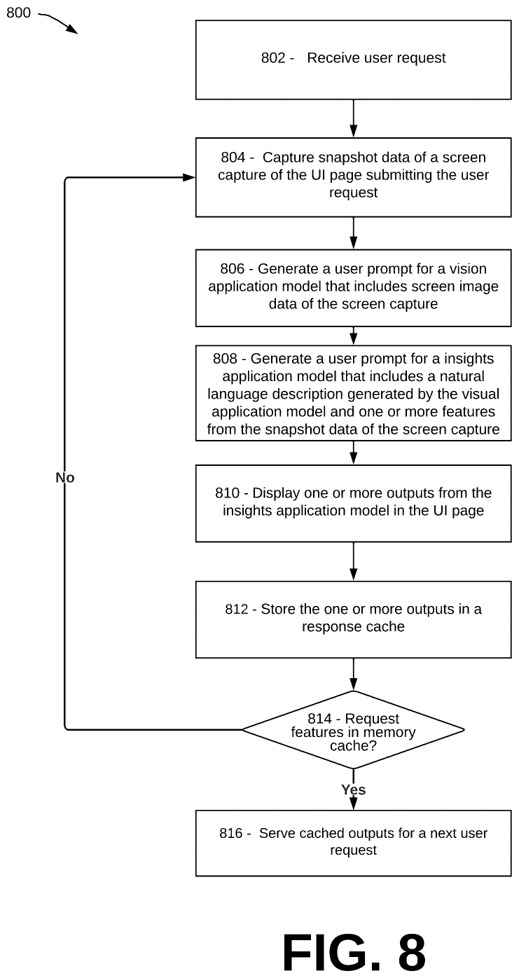

The language model interface may use the trained application models to generate responses to one or more text generation requests. FIG. 8 is a block diagram illustrating an example process 800 for generating one or more insights and/or recommendations using the language model interface. At step 802, the language model interface receives a text generation request from an application. The text generation request may include a request for AI system functionality, for example, a request for an agentic application and/or application model to generate an output or perform a task. At step 804, the capture components may capture snapshot data of a screen capture of the UI page that generated the text generation request. The snapshot data may include screen image data of a portion of the UI page and one or more pieces of application data extracted from the machine readable code (e.g., HTML/CSS) used to render the UI page. For example, the capture components may extract from the machine readable code one or more application interactions with the application performed to generate the UI page and/or context data for the user and the datasets shown in the UI page.

One or more generative systems may use request features determined from the snapshot data to generate a response for the text generation request. A prompt generator may generate one or more user prompts that include one or more of the request features and, optionally, instructions to generate a response and one or more response guidelines. The user prompts may be formatted to be received by an application model and may be displayed to the application model to generate a response to the text generation request. An agentic application (e.g., an agentic application configured as a marketing analyst) may also be used to generate the response. To generate the response using an agentic application, a prompt generator may generate an agent call for an analyst agent. The agent call may format the text generation request as an agent prompt that may be processed by the analyst agent.

At step 806, the analyst agent may generate a user prompt for a vision model. The user prompt may include one or more image features (e.g., the screen image data) determined from the snapshot data of UI page generating the text generation request and instructions including a task for the vision model to perform (e.g., generate a natural language description of the data displayed in the graphs or other objects included in the screen image data). The analyst agent may input the user prompt to the vision model to generate a natural language description for the screen image data.

At step 808, the analyst agent may generate a user prompt for an insights model that includes one or more request features. The request features may include the text generation request, one or more image features (e.g., the screen image data and the natural language description of the screen image data generated by the vision model) and one or more application interaction features and/or one or more context features. The user prompt may also include instructions including a task for the insights model to perform (e.g., generate one or more insights and/or one or more recommendations based on a comparison of the data segments displayed in a graph or other object captured in the screen image data and the other request features). The analyst agent may input the user prompt to the insights model to generate a text response (e.g., one or more insights and/or recommendations). The user prompt may also include one or more response guidelines that instruct the insights model to return the generated text response in a machine readable format (e.g., JSON, XML, YML, and the like) so that the language model interface may programmatically provide the generated insights and/or recommendations to the application submitting the text generation request.

At step 810, one or more outputs from the generative components may be displayed in a UI page of the application that generated the text generation request. To display the outputs, the language model interface may make the text response generated by the insights model accessible to a device associated with the text generation request. For example, the language model interface may provide a machine readable format of the one or more insights and/or recommendations generated by the insights model to an application programming interface that may send the insights and/or recommendations to a device running an instance of the application. The application may cause the device to display the insights and/or recommendations in the UI page that generated the text generation request by loading the insights and/or recommendations in the application data used to render the UI page. The insights and/or recommendations may be displayed in an area of the UI page generating the text generation request that is adjacent to the graph or other object discussed in the insights and/or recommendations. For example, the UI page may include a button that if selected generates a text generation request for an insight and/or recommendation. The language model interface may receive the text generation request, generate the insight and/or recommendation, and send the insight and/or recommendations back to the application for display in a portion the UI page. For example, the application may load the generated insights and/or recommendations in the application data used to render the area of the UI page that included the button and/or an area of the UI page adjacent to a graph or other visualization related to the generated insights and/or recommendation.

At step 812, the language model interface may store the outputs generated for the text generation request (e.g., the generated insights and/or recommendations) in a responses cache (e.g., a memory cache configured to store outputs generated by application models). The language model interface may generate a configuration id for each set of stored insights and/or recommendations that is unique to the user prompt used to generate the insights and/or recommendations. The configuration id may be determined based on the request features included in the user prompt and a different configuration id may be generated for each output (e.g., each set of insights and/or recommendations) having a different set of request features. The language model interface may retrieve outputs stored in the responses cache by matching the request features in a new user prompt to the request features in the configuration ids of the outputs in the responses cache.

The responses cache may improve the efficiency and performance of the language model interface by reducing the number of text generation requests that must be processed by the generative components. The responses cache may also enhance the user experience of the application by making the response generated by the application models more consistent. For example, the responses cache may enable the language model interface to provide the same outputs each time the language model interface receives a text generation request from the same UI page. Users that want to regenerate the insights and/or recommendations for a particular UI page and/or share the insights and/or recommendations with other users, may configure the application to generate the particular UI page and submit a text generation request to the language model interface form the UI page. The language model interface may generate a user prompt for the text generation request that includes request features for the particular UI page. The language model interface may lookup the request features in the responses cache to identify a configuration id for an output that matches the request features. The language model interface may use the matched configuration id to retrieve the original insights and/or recommendations from the responses cache and the retrieved insights and/or recommendations may be provided to the application for display in the UI page. Without the responses cache, the language model interface would regenerate new outputs for each text generation request even if an identical request from the same UI page had been submitted before. The insights and recommendations generated by the language model interface are set up to be different every time which may be undesirable in some cases. For example, the lack of consistency may cause users to lose trust and/or confidence in the insights and/or recommendations and make it more difficult for users to collaborate on projects in the application. Generating a new response for the same text generation request may also increase the compute and cost of operating the language model interface may increasing the number of operations run by the application models. The responses cache solves both of these problems by reducing the number of text generation requests that are possessed by the application models and enabling user to regenerate the same outputs for text generation requests from the same UI page.

At step 814, the language model interface may look up the request features in a user prompt for a new text generation request in the configuration ids for the outputs in the response cache. If the language model interface identifies a matching configuration id (Yes at 814), the cached output linked to the matched configuration id may be retrieved and the language model interface may serve the cached outputs to the application interface component, at step 816, in response to the new text generation request. If the language model interface does not identity a configuration id matching the request features (No at 814), the responses cache will not return any outputs and the generative components may generate a new output for the new text generation request by repeating steps 802-812.

In this disclosure, the following definitions may apply in context. A “Client Device” or “Electronic Device” refers to any machine that interfaces to a communications network to obtain resources from one or more server systems or other client devices. A client device may be, but is not limited to, a mobile phone, desktop computer, laptop, portable digital assistant (PDA), smart phone, tablet, ultra-book, netbook, laptop, multi-processor system, microprocessor-based or programmable consumer electronic system, game console, set-top box, or any other communication device that a user may use to access a network.

“Communications Network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and coupling may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

“Component” (also referred to as a “module”) refers to a device, physical entity, or logic having boundaries defined by function or subroutine calls, branch points, application programming interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors.

It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instant in time. For example, where a hardware component includes a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instant of time and to constitute a different hardware component at a different instant of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Image data” in this context refers to any type of visual media or other data that includes a number of rows and columns or pixels including, for example, images, frames of video, three dimensional holograms, pixel data, virtual reality (VR) content, augmented reality (AR) content, mixed reality (MR) content, extended reality (XR) content, and the like.

“Machine-Readable Medium” in this context refers to a component, device, or other tangible medium able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EPROM)), and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“Processor” refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), or any combination thereof. A processor may further be a multi-core processor having two or more independent processors (sometimes referred to as “cores”) that may execute instructions contemporaneously.

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

Although the subject matter has been described with reference to specific example embodiments, it will be evident that various modifications and changes may be made to these embodiments without departing from the broader spirit and scope of the disclosed subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Description, therefore, is not to be taken in a limiting sense, and the scope of various embodiments is defined only by any appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more processors; and
a memory storing instructions that, when executed by at least one processor in the one or more processors, cause the at least one processor to perform operations for generating a text response corresponding to an object displayed in a user interface (UI) page, the operations comprising:
capturing snapshot data for multiple UI pages generated by an application, each piece of snapshot data including a piece of screen image data of a portion of a UI page that is rendered during an application usage session, application interaction data captured during the application usage session, and context data for a user;
inputting the snapshot data for each UI page into a snapshot encoder configured to generate, one or more image embeddings representative of a portion of the screen image data, one or more interaction embeddings representative of a portion of the application interaction data, and one or more context embeddings representative of a portion of the context data;
aggregating the one or more image embeddings, one or more interaction embeddings, and one or more context embeddings into an encoded vector for the snapshot data for a particular UI page; and
generating a system prompt for the encoded vector by determining a natural language description for each of the embeddings in the encoded vector.

2. The system of claim 1, wherein the one or more processors are further configured to provide the system prompt to an insights model configured to generate one or more natural language insights for the particular UI page.

3. The system of claim 2, wherein the one or more natural language insights include one or more follow up actions to perform in an application connected to the insights model.

4. The system of claim 2, wherein the one or more processors are further configured to collect feedback data for the one or more natural language insights in response to a performance of at least one of the one or more follow up actions; and
retrain the insights model based on the feedback data.

5. The system of claim 1 wherein the at least one processor is further configured to execute instructions to perform operations comprising:
inputting a new text generation request from a new UI page, a piece of screen image data of a portion of the new UI page, one or more image features for the new UI page generated by the vision model, and one or more snapshot features for the new UI page, into the insights model configured to generate, based on at least one of the piece of screen image data of a portion of the new UI page, the one or more image features for the new UI page, and the one or more snapshot features for the new UI page, a text response for the new text generation request; and
make the new text response, generated by the insights model, accessible to a device associated with the new text generation request.

6. The system of claim 1, wherein the image features for each UI page include a text description of one or more objects included in each piece of screen image data.

7. The system of claim 1, wherein the processor is further configured to execute instructions to perform operations comprising:
generating a image training file including the screen image data for each UI page and an example response including a text description of an object included in the screen image data;
inputting a image training prompt including a training portion of the image training file into to an image to text language model configured to generate, based on the training prompt, a generated text description; and
training the vision model using the generated text description.

8. The system of claim 1, wherein the one or more snapshot features include at least one of one or more application interaction features and one or more context features.

9. The system of claim 8, wherein the one or more application interaction features are determined from one or more application interactions performed to configure the application to generate each of the UI pages.

10. The system of claim 8, wherein the one or more context features are determined from context data related to at least one of a user of the application submitting a text generation request from one of the UI pages and a dataset displayed in one of the UI pages.

11. The system of claim 1, wherein the processor is further configured to execute instructions to perform operations comprising:
generating an example response for a text generation request received from each of the multiple UI pages; and
training the insights model based on the example response and the output response for each UI page.

12. The system of claim 11, wherein the processor is further configured to execute instructions to perform operations comprising:
generating a performance score for the language model by calculating a cosine similarity for an output response vector determined for each of the one or more output responses to an example response vector determined for a corresponding example response; and
training the insights model by modifying one or aspects of the language model based on the performance score.

13. The system of claim 1, wherein the processor is further configured to execute instructions to perform operations comprising:
collecting feedback data for the text response; and
retraining the insights model using the feedback data and the text response.

14. A system comprising:
one or more processors; and
a memory storing instructions that, when executed by at least one processor in the one or more processors, cause the at least one processor to perform operations comprising:
capture snapshot data for multiple UI pages generated by an application, each piece of snapshot data including a piece of screen image data of a portion of one of the multiple UI pages;
accessing the piece of screen image data for each UI page and inputting the accessed pieces of screen image data into an image encoder;
receiving, from the image encoder, an image embedding;
inputting at least one of the piece of screen image data and the image embedding into a first sub model configured to generate, based on the at least one of the piece of screen image data and the image embedding, a corresponding text embedding;
inputting at least one of the piece of screen image data, the image embedding, and one or more features determined from application data used to render the UI page into a second sub-model configured to generate based on the piece of screen image data, the image embedding, and the one or more features, an output response;
making the output response accessible to a device, wherein the device is at least one of:
configured to train an insights model using the output response and associated with a text generation request.
